(19) United States
(12) Patent Application Publication
(10) Pub. No.: US 2026/0275841 A1
(43) Pub. Date: Sep. 17, 2026

(54) SYSTEM AND METHOD FOR ENHANCED OIL RECOVERY UTILIZING ALTERNATING STACKED LIQUID AND GAS SLUGS

(71) Applicant: EOR ETC LLC, Houston, TX (US)

(72) Inventors: Stuart Lindsey SCOTT, Pearland, TX (US); Adrian Paul WILLIAMS, Brenham, TX (US); Bradon Jay MOORE, San Antonio, TX (US)

(73) Assignee: EOR ETC LLC, Houston, TX (US)

(21) Appl. No.: 19/679,036

(22) Filed: May 15, 2026

Related U.S. Application Data
(63) Continuation-in-part of application No. 19/007,337, filed on Dec. 31, 2024.
Application No. 19/007,337 is a continuation of application No. 17/802,918, filed on Feb. 28, 2021, now Pat. No. 12,180,814.
(60) Provisional application No. 62/983,354, filed on Feb. 28, 2020.

(51) Int. Cl. E21B 43/16; G05D 11/13

(52) U.S. Cl. CPC E21B 43/166; G05D 11/13

(57) ABSTRACT

A system for conducting enhanced oil recovery includes a buffer tank configured to contain liquid, gas, or a liquid-gas mixture, and a level sensor associated with the buffer tank. The level sensor is configured to determine fluid levels within the buffer tank and to generate vertical density measurements across a height of the buffer tank. A fluid dispensing system is in fluid communication with the buffer tank and is configured to selectively deliver gas segments and liquid segments from the buffer tank to a wellbore. The delivered gas and liquid segments form a plurality of stacked, alternating gas segments and liquid segments that travel downhole into the wellbore for enhanced oil recovery operations.

This application claims priority to U.S. Non-Provisional patent application Ser. No. 19/007,337, filed on Dec. 31, 2024, which is a continuation of U.S. Non-Provisional patent application Ser. No. 17/802,918, filed on Aug. 26, 2022, now issued as U.S. Pat. No. 12,180,814. Application Ser. No. 17/802,918 is a National Stage Entry of International Application No.: PCT/US21/20155, filed Feb. 28, 2021, which claims priority to U.S. Provisional Patent Application No. 62/983,354, filed on Feb. 28, 2020. The content of each aforementioned application is incorporated herein by reference in their entirety.

### TECHNICAL FIELD

The present technology provides solutions for oil recovery, and in particular, for enhanced oil recovery (EOR) techniques that utilize an injection process that injects a series of alternating slugs of gas and liquid into a subterranean well.

### BACKGROUND

Known Enhanced Oil Recovery (“EOR”) methods generally have incorporated routines referred to as Water Alternating Gas (WAG) that entail injecting gas for an extended period of time (at least hours, and sometimes days), then injecting water for a similar period, and repeating the two until a target recharged pressure is achieved in the formation of interest.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of aspects presented herein.

FIG. 1 illustrates example gradient curves of pressure versus depth that would exist for all-liquid (water) injection (left-most straight-line curve), all-gas injection (right-most, vertical straight-line curve) and rapidly alternating liquid/gas injection (middle straight-line curve) in accordance with aspects of the RSSS (Rapid-Switch, Stacked-Slug) embodiment of the present disclosure.

FIG. 2 illustrates example gradient curves of pressure versus depth that would exist for all liquid (water) injection (left-most), all gas injection (right-most) and continuously mixed-phase (liquid and gas) injection (middle solid line) in accordance with aspects of the continuous, mixed-phase injection embodiment of the present disclosure.

FIG. 3 illustrates an example operational envelope for a process delivered by a surface module in accordance with aspects of the present disclosure.

FIG. 4 illustrates an example system that utilizes compressed gas and pumped liquid that are variously combined in accordance with aspects of the present disclosure.

FIG. 5 illustrates an example system that utilizes compressed gas and pumped liquid that are combined in a buffer tank in accordance with aspects of the present disclosure.

FIG. 6 illustrates an example of a mixed-phase injection system in accordance with aspects of the present disclosure.

FIG. 7 illustrates an example of the mixed-phase injection system of FIG. 6 denoting corresponding skids on which various components can be positioned in accordance with aspects of the present disclosure.

FIG. 8 illustrates an example of the mixed-phase injection system of FIG. 6, but featuring the comingling spool that acts as a mixer of the liquid and gas phases in accordance with aspects of the present disclosure.

FIG. 9 illustrates an example mixed-phase injection mode of the injection system of FIG. 6 in accordance with aspects of the present disclosure.

FIG. 10 illustrates an example fluid dispensing system of an injection system configured in accordance with aspects of the present disclosure.

FIGS. 11-19 illustrate example configurations, assumed in various sequences, of an injection system configured in accordance with aspects of the present disclosure, exemplarily operating in a rapidly alternating phase mode.

FIG. 20 illustrates example skid configurations, equipment allocations thereon and containers in which the skids can be housed in accordance with aspects of the present disclosure.

FIG. 21 illustrates an example of the injection system of FIG. 6 including electrical power components and a communication system configured in accordance with aspects of the present disclosure.

FIG. 22 illustrates a simplified configuration of tubing within the well casing of a horizontal well (completed without a packer) depicting the annular flow path therebetween in accordance with aspects of the present disclosure.

FIG. 23 illustrates an example of injected fluids moving from an injection well, pushing reservoir oil toward a producing well in accordance with aspects of the present disclosure.

FIG. 24 illustrates an example of injecting fluids into a depleted or partially depleted well in accordance with aspects of the present disclosure.

FIG. 25 illustrates an example of diversion of an injected flow in accordance with aspects of the present disclosure.

FIG. 26 illustrates an example slug unit including a liquid slug and gas slug taking the form of an entrained bubbles region in accordance with aspects of the present disclosure.

FIG. 27 illustrates an example gas bubble slug and liquid slug length chart in accordance with aspects of the present disclosure.

FIG. 28 illustrates an example of an injection system analysis plot in accordance with aspects of the present disclosure.

FIG. 29 illustrates an example chart demonstrating fluid injection rates (liquid phase, gas phase and mixed and/or alternating phase) in accordance with aspects of the present disclosure.

FIG. 30 illustrates examples of end-to-end volumes in a reservoir in accordance with aspects of the present disclosure.

FIG. 31 illustrates an example parent and child well interaction in accordance with aspects of the present disclosure.

FIGS. 32A-B illustrate an example EOR system configured for co-injection of alternating gas segments and liquid segments including entrained gas bubbles delivered to a wellbore, in accordance with aspects of the present disclosure.

FIG. 33A illustrates a graph of estimated bottomhole pressure using a dead-string estimation approach compared to measured bottomhole pressure, in accordance with aspects of the present disclosure.

FIG. 33B illustrates another graph of estimated bottomhole pressure over a portion of an injection interval, in accordance with aspects of the present disclosure

FIG. 34A illustrates a flow chart of a method for measuring bottomhole pressure, in accordance with aspects of this disclosure;

FIG. 34B illustrates another flow chart of a method for measuring bottomhole pressure, in accordance with aspects of this disclosure;

FIG. 35A illustrates a graph of a recovery-trend of a water-based injection process, in accordance with aspects of the present disclosure.

FIG. 35B illustrates a graph of a recovery-trend for an RSSS co-injection process, in accordance with aspects of the present disclosure.

FIG. 36A illustrates a graph of modeled bottomhole pressure for an RSSS co-injection model, in accordance with aspects of the present disclosure.

FIG. 36B illustrates a graph of percent-difference associated with the modeled bottomhole pressure in FIG. 36A, in accordance with aspects of the present disclosure.

FIG. 36C illustrates a graph of a distribution of percent-difference values of the graph in FIG. 36B, in accordance with aspects of the present disclosure.

FIG. 37 illustrates a block diagram of a method for modeling bottomhole pressure, in accordance with aspects of this disclosure.

FIG. 38 illustrates a flow diagram of a method for operating an enhanced oil recovery system, in accordance with aspects of this disclosure.

FIG. 39 illustrates an example processor-based system with which some aspects of the subject technology can be implemented, in accordance with aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “coupled” is defined as connected, whether directly or indirectly through intervening components, and is not necessarily limited to physical connections. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “about” means reasonably close to the particular value. For example, about does not require the exact measurement specified and can be reasonably close. As used herein, the word “about” can include the exact number. The term “near” as used herein is within a short distance from the particular mentioned object. The term “near” can include abutting as well as relatively small distance beyond abutting. The terms “comprising,” “including” and “having” are used interchangeably in this disclosure. The terms “comprising,” “including” and “having” mean to include, but not necessarily be limited to the things so described.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X and Y; Y and Z; X and Z; X, Y, and Z). Likewise, conjunctive language such as the phrase “at least one of X, Y, and Z,” unless specifically stated otherwise, is generally intended, within the context presented, to disclose at least one of X, at least one of Y, and at least one of Z. “At least one of X, Y, and/or Z” is intended to include the disjunctive and conjunctive possibilities.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

Although a variety of information is used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

In a related aspect, if one item is recited in the claim, that limitation covers one or more of that item as for instance, two of a certain item comprises one of those items, unless expressly claimed as being a single item or otherwise limited to one item, and no more.

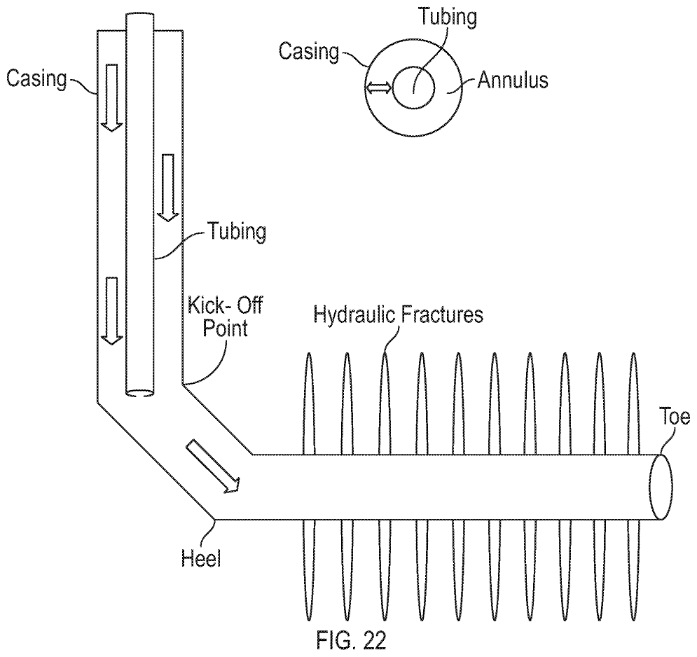

Re-pressuring injection for Enhanced Oil Recovery can be delivered into a depleted or partially depleted well in a number of ways. To reduce frictional pressure losses, injection using the largest available flow path is most often desired. However, too large of a flow path can reduce velocities below minimum needs. In most cases, the typical flow paths down oil and gas wells are suitable. Most generally, there are typically three flow paths. The first flow path is bounded by the well's casing formed by an outer string of pipe contacting the formation (typically, rock). The second flow path is formed by the well's tubing string that is smaller pipe within the casing typically used to improve production and can be used to implement various artificial lift methods. The third flow path is annulus defined by the annular space between the casing and the tubing. FIG. 22 illustrates an example casing and tubing in a horizontal well completed without a packer to highlight the annular flow path. Horizontal wells are Hydraulic Fracture Stimulated resulting in vertical fractures extending away from the wellbore at designed intervals. For annular injection, the injected fluid moves down through the annulus in the vertical and near vertical sections of the wellbore. The end of the tubing is typically positioned near the kick-off point where the vertical section transitions (curves) into the horizontal section. In EOR, injected fluid travels into the horizontal wellbore and exits into one or more of the vertical fractures and into contact with the reservoir rock through the natural and created fracture system extending into the reservoir. In accordance with the present disclosure, rapidly alternating slugs of gas and liquid injected down the annulus are designed to continue reasonably unmixed into the horizontal wellbore section.

In some instances, the wellbore can be entirely used for EOR injection such that the full casing diameter is effectively available for injection flow by way of simultaneous injection down the annulus and the inner tubing string. Whether the casing can be used for EOR injection typically depends on local/regional regulations. Use of the casing for EOR may be prohibited to prevent unintended leakage of pressured fluids before reaching the intended formation. If tubing injection is required, the EOR fluids are injected down the inner tubing and are prevented from flowing back up the annulus by a packer set between the tubing and the casing, above the bottom opening of the tubing, thereby sealing off the annulus as an upward pathway.

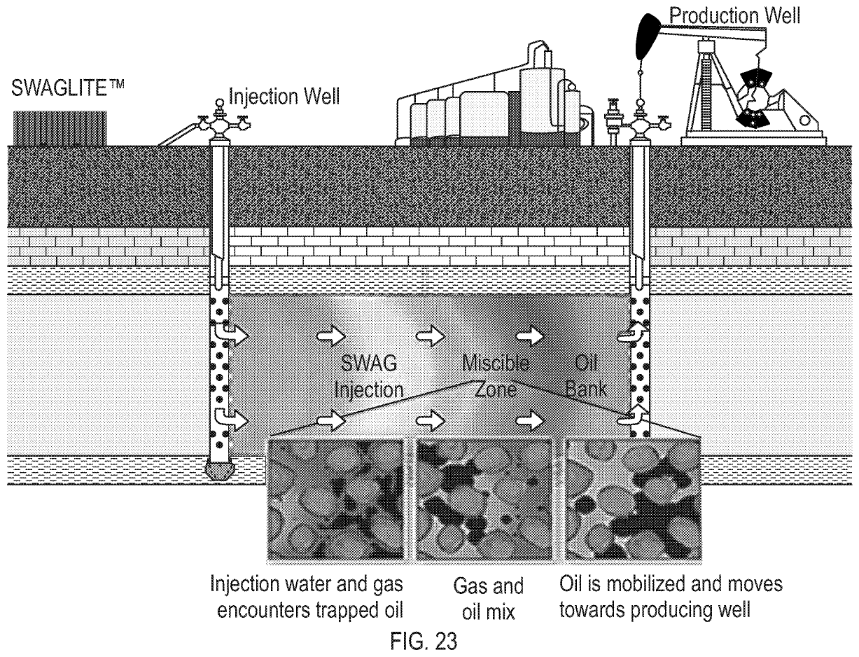

Referring to FIG. 23, an example EOR process is illustrated in which injected fluids move from an injection well toward a producing well, and in the process push recoverable hydrocarbons to the producing well. In some instances, this type of injection has been referred to as a Simultaneous Water and Gas (SWAG) EOR process, but current methods for performing SWAG have rarely been implemented in the field due to phase segregation/separation problems (entrained gas separating out of the entraining liquids). In other configurations, SWAG injection can be performed in which one injection well moves fluids (radially outward) toward four (or more) surrounding producing wells (e.g., 5-spot) or in a pattern in which a line of injection wells move fluid toward a line of producing wells (e.g., line-injection).

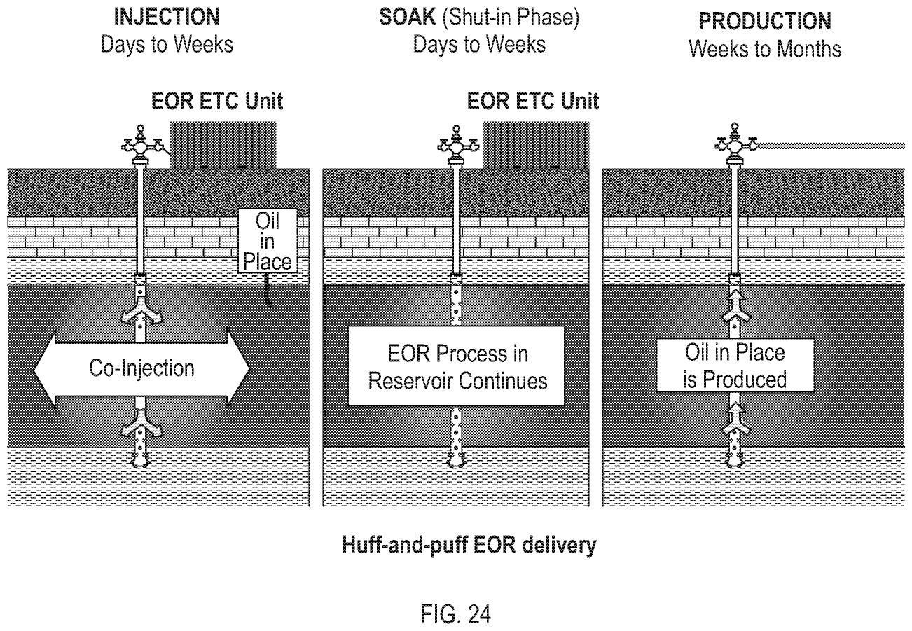

During an EOR process, all of the well's flow paths are maintained for subsequent recharged production utilizing the tubing and various types of artificial lift (e.g., gas lift, jet pump, plunger lift, Electrical Submersible Pump (ESP), or rod pumping). FIG. 24 illustrates an example sequence in which recharge injection is performed upon a depleted or partially depleted well (left-hand illustration). This injection can occur over a period of several weeks, or longer. After injection, the well can be shut in for a “soak” period that can last for days, weeks or months. However, the soak period can also be dispensed with entirely, and production can begin when the recharge injection is completed. Regardless, the well is then put back on production and typically flowed for several months. This recharge/production cycle can be repeated multiple times until an economic limit is reached.

In the realm of Enhanced Oil Recovery, “diversion” refers to the sealing off of high conductivity flow paths (e.g., highly permeable formation zones) using “diverter” material so that the flow of injected recharge fluids is forced into less conductive flow paths. High pressure gas injection EOR processes do not lend themselves to diverter placement because the injected gas is not a good carrier of industry standard diverter. This includes fracturing balls/ropes, packers/plugs, caking materials (e.g., to reduce leak-off by building a filter cake on the rock of the flow path), viscosity enhancers and other related chemicals. In the instance of recharging with high-pressure gas, the injected gas moves along the path of least resistance and repeatedly treats the same fractures, cycle after cycle, thereby limiting reservoir contact, recovery, and production. These effects can be reduced if physical plugs are placed in the well in a process requiring an in-well intervention. The injection process enables many diverting methods that do not require an in-well intervention, although setting plugs is also possible with this process.

The presently disclosed recharge injection processes provide an ability to place diverter material and effectively seal off a set of fractures and divert flow into another set of fractures without the necessity of setting any plugs. These injection processes not only inject recharge fluid into high conductivity fractures, but a multitude of sequences can be devised to divert the EOR recharge fluids to other fractures in the wellbore. For example, injection without diversion can be performed for the first several (one to three) injection cycles. When recovery is observed to sufficiently decrease cycle-over-cycle, a dissolvable rope-type diverting agent can be pumped with the liquid slugs on subsequent cycles (four and more) to seal-off perforations or flow conduits (or at least decrease their permeability to the recharge fluid) that had taken up the injected recharge fluids in the initial injection cycles. In this manner, subsequent recharge fluid flow is diverted to fractures now having the lowest permeability (highest conductivity) in the formation, thereby exposing additional reservoir rock to both miscible gas and surfactant.

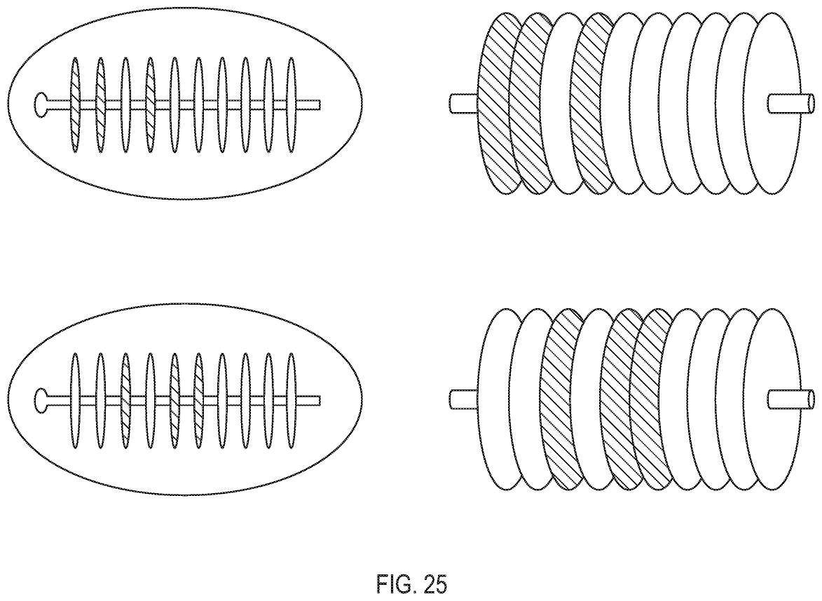

FIG. 25 illustrates an example of a diversion of an injected flow, where the first three injection cycles mainly flowed into the 1^{st}, 2^{nd}, and 4^{th} fractures (from the left, and as depicted in the top row). After diversion, these high conductive paths are temporarily sealed off and the injected recharge fluids flow into the 3^{rd}, 5^{th}, and 6^{th} fractures (from the left, and as depicted in the bottom row). This diversion process can be repeated in an iterative fashion to treat additional fractures and reservoir rock boosting recovery and production using the presently disclosed injection systems and processes.

As described herein, the present technology relates to systems and methods for enhanced oil recovery (EOR) techniques in which surface equipment is utilized to provide an ability to inject a combination of gas and liquid into a subterranean well or wells from at or near the surface. An aspect of the technology is that it requires significantly less surface injection pressure as compared to currently utilized high pressure compressed gas injection for similar enhanced oil recovery procedures. Still further, in addition to utilization in enhanced oil recovery, the techniques described herein can also be employed on storage/disposal wells used for subsurface gas/liquid storage or disposal.

The present technology allows for a self-contained system for recharging/repressurizing an oil well that has declined in production, and especially oil wells located in shale reservoirs, for enhanced oil recovery. The injection systems as described herein provide a low-cost method for increasing recovery from existing wells and significantly reduces the requirement to drill more expensive in-fill wells. The injection system of the present disclosure can also be utilized for multiple alternative applications that may require subsurface gas and liquid injection in line with ongoing initiatives such as fracturing hit protection, produced gas storage, CO₂ disposal, and produced water disposal. The injection system can include high frequency, alternating gas and liquid injection into a wellhead. This requires significantly lower surface injection pressure and lower power compared with alternative EOR systems. The injection system also provides a lower safety risk due to lower operation pressure, enclosed construction, and remote operation. The injection system as disclosed herein also includes containerized injection skids for easy transportation, deployment, commissioning, and operation. The injection system also provides remote operation with remote monitoring and local operation. Stabilized liquid and gas injection pressure can be maintained by the buffer tank of the injection system in conjunction with an injection pump configured to operate level control modes. In one example, the injection system provides rapid, high speed switching between liquid and gas injection slugs thereby establishing a series of alternating stacked liquid/gas slugs in a well with accurate injection rates and volume controls utilizing a flow control system as described herein including flowmeters, flowrate control valves, and high speed open/close valve configurations.

In at least one embodiment, a system for conducting Rapid-Switch, Stacked-Slug (RSSS) enhanced oil recovery is disclosed for establishing a plurality of stacked, alternating slugs of gas and liquid travelling downhole into a subterranean well. The system comprises (includes, but is not limited to) a buffer tank having a liquid inlet through which liquid is received from a liquids source into the buffer tank and a gas inlet through which gas is received from a pressured gas source into the buffer tank. The buffer tank also has a gas outlet in fluid communication with gas reservoired in the buffer tank and a liquid outlet in fluid communication with liquid reservoired in the buffer tank. The system includes a pressure control configured to maintain a specified pressure in the gas reservoired within the buffer tank and exerts a corresponding pressure on liquid also reservoired within the buffer tank. A fluid dispensing system is provided that has fluid communication with the gas and liquid outlets of the buffer tank and is controlled to deliver alternating slugs of gas and liquid to a subterranean wellhead. In this manner, the system establishes a plurality of stacked, alternating slugs of gas and liquid travelling downhole into a subterranean well.

Relatedly, a method for conducting enhanced oil recovery is also disclosed that establishes a plurality of stacked, alternating slugs of gas and liquid travelling downhole into a subterranean well. The method includes providing an enhanced oil recovery system having a buffer tank including a liquid inlet through which liquid is received from a liquids source into the buffer tank and a gas inlet through which gas is received from a pressured gas source into the buffer tank. The buffer tank also includes a gas outlet in fluid communication with gas reservoired in the buffer tank and a liquid outlet in fluid communication with liquid reservoired in the buffer tank. A pressure control maintains a specified pressure in gas reservoired within the buffer tank and the pressured gas reservoired within the buffer tank exerts a corresponding pressure on liquid reservoired within the buffer tank. A fluid dispensing system provides fluid communication with the gas and liquid outlets of the buffer tank and is controlled to deliver alternating slugs of gas and liquid to a subterranean wellhead. The fluid dispensing system dispenses the alternating slugs of gas and liquid into the subterranean wellhead, thereby establishing a plurality of stacked, alternating slugs of gas and liquid travelling downhole into a subterranean well.

As such, a need exists for Enhanced Oil Recovery (EOR) techniques that utilize an injection process that injects a combination of gas and liquid into a subterranean well, and that are relatively inexpensive.

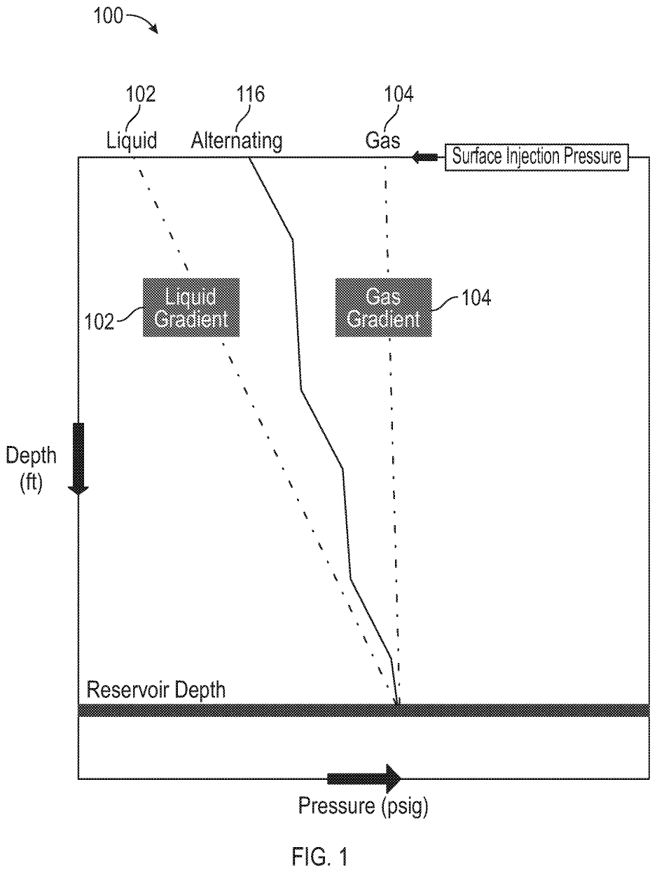

FIG. 1 illustrates example gradient curves of pressure versus depth 100 that would exist for single-phase water injection 102 and gas injection 104. Water injection pressures are low due to the weight of the high-density liquid. The hydrostatic pressure gradient of water 102 is nearly a straight line as the fluid is only slightly compressible. During the gas injection phase of the traditional WAG process 104, the surface injection pressure is very high, typically near or slightly above the reservoir pressure. The hydrostatic gradient of the gas 104 in the tubing is very small due to the lower density of gas when compared with a liquid.

Shown between these two gradients 104, 106 is an example alternating gradient of the present disclosure where gas and liquid are injected into the wellbore in reasonably rapidly alternating slugs, but at least sufficiently rapid to create a stack of a plurality of alternating slugs in the wellbore. It should be appreciated that the alternating injection pressure 106 is lower than the surface injection pressure for single-phase gas 104. The pressure of the alternating injection pressure 106 is also higher than that used for the injection of single-phase water 102. While this tends to indicate a trade-off of benefits between the water and gas injection phases (lower pressure seemingly to be most desirable), in actuality, gas compression is much more energy intensive than liquid (e.g., water) pumping. Therefore, energy efficiency is improved by the presently disclosed rapid phase (liquid/gas) alternating injection process 100 as compared to known WAG processes. Also, facility modifications to implement the presently disclosed injection processes 100 are reduced further when an intermediate gas pressure source is available. This is common, both offshore and onshore, where a sales compressor can be a source for the injected gas and may already present the capabilities prescribed by the technology and techniques presently disclosed.

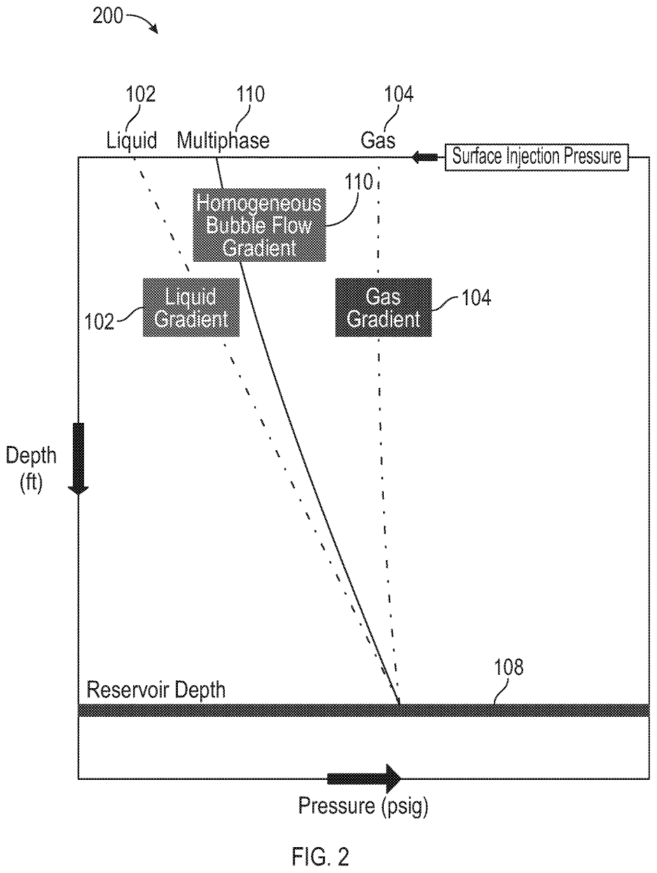

Aspects of the presently disclosed technology include injection enhancement methods that enable reduced energy consumption and improvements in reservoir recovery. FIG. 2 illustrates an example gradient curve 200 of continuous mixed phase injection in accordance with aspects of the present disclosure. First, as illustrated in FIG. 2, given an available pressure from a surface gas source, there is an optimal amount of complimentary liquid that is required to obtain and maintain injectivity to the reservoir at a particular time during the injection cycle 110 from wellhead to target formation depth. If more liquid is added than is required for its needed weight contribution to the drive pressure, less gas is provided to the reservoir, reducing flowback energy. If the liquid added is too little to assist in driving the gas component to the target formation, then injectivity may be lost as pressure at the bottomhole 108 of the wellbore may be less than reservoir pressure.

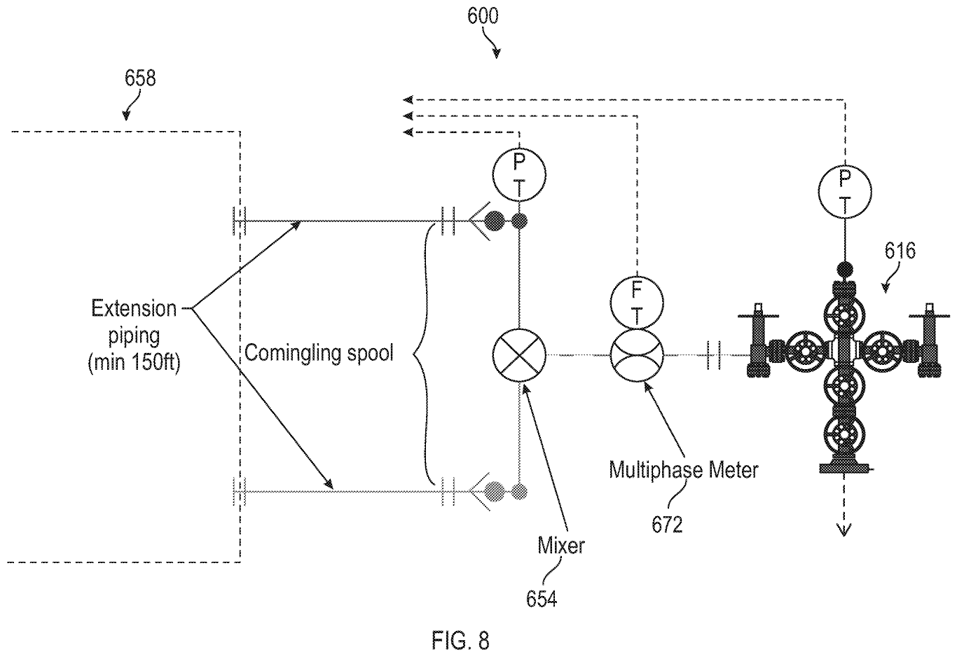

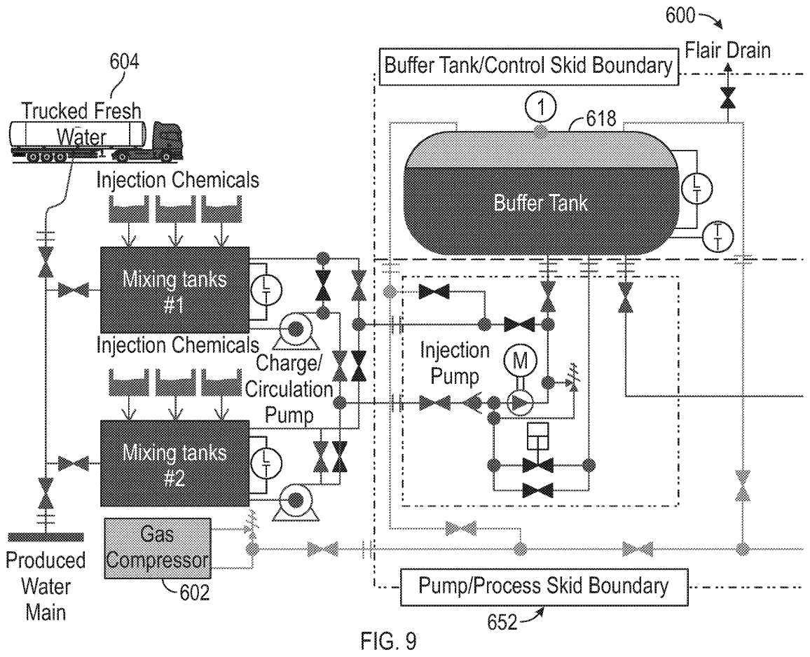

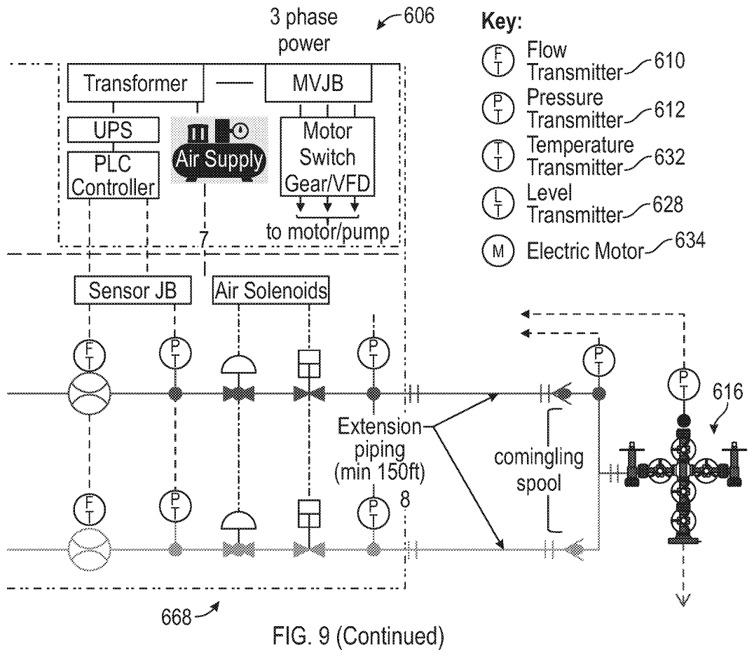

In addition to optimizing the liquid content of the mixed-phase stream 110 to achieve and maintain injection with minimum energy usage, there may be a desired ratio of liquid and gas at the reservoir for two-phase permeability. The permeability of the reservoir will vary due to the various relative permeabilities to gas and liquid. According to the present disclosure, there may be target liquid-to-gas volume ratios for a particular completion reservoir. This can be achieved by affecting adjustments in surface injection pressure and regulating the gas and water injection rates at the surface. The mixed-phase gradient 110 can be a homogeneous gas-bubble-in-liquid flow gradient. A mixed-phase injection 110 may utilize a no-slip homogeneous bubble flow and very high velocities and liquid-volume-fractions. The mixed-phase injection 110 may be achieved by utilizing a mixer 654 (as shown in FIG. 8) along with an injection system (e.g., injection system 600 as illustrated in FIG. 9).

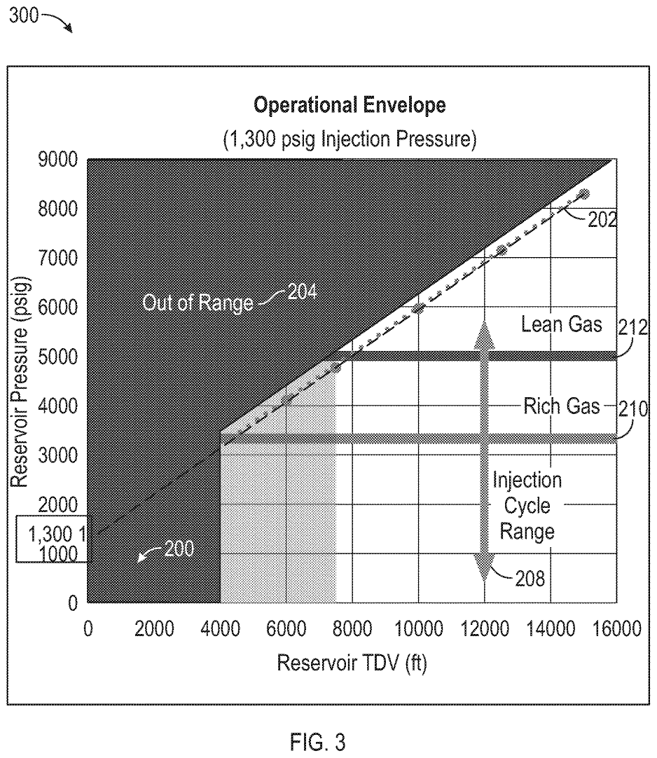

FIG. 3 illustrates an operational envelope for a process 300 delivered by a surface module of the presently disclosed technology, and which can be defined by an available surface pressure, depth of the reservoir, and density of the injected liquid and gas. In FIG. 3, the line 202 extending to the upper right from the example surface injection pressure of 1,300 psig is the hydrostatic gradient for a single-phase liquid brine. The region above that line can be out of range 204 for the process 300. This line moves up and down depending on the available surface injection pressure. The region in the lower left corner 206 (under the line 202 in grey) also illustrates an out-of-range zone for the process 300. The right side of the box is defined by a vertical line 208 intersecting a Rich Gas line 210. The Rich Gas line 210 and a Lean Gas line 212 vary with the composition of the injection gas and the reservoir oil. In this example, reservoir depths below 4000 feet, true vertical depth (TVD) are out of range.

The downhole pressure is directly dependent on the source gas pressure, densities, and reservoir depth. As illustrated in FIG. 3, shallow and high pressure reservoirs (e.g., above a hydrostatic gradient) are better candidates for this process 300 and module of the present disclosure. Still further, depleted reservoirs are also good candidates for application of the present technology.

FIG. 3 further illustrates an example implementation for a 12,000 foot deep reservoir having a 1,300 psig gas supply pressure. In this example, due to earlier extraction (e.g., production) activities, the reservoir pressure has been reduced to 500 psig. In some implementations, the well and reservoir can be recharged over time to a pressure above the minimum miscibility pressure for the gas and reservoir oil. If rich gas is utilized for the injection, the re-charge pressure can be approximately 4,000 psig, but if a lean gas such as methane is available and utilized, the re-charge pressure can be higher at approximately 5,500 psig.

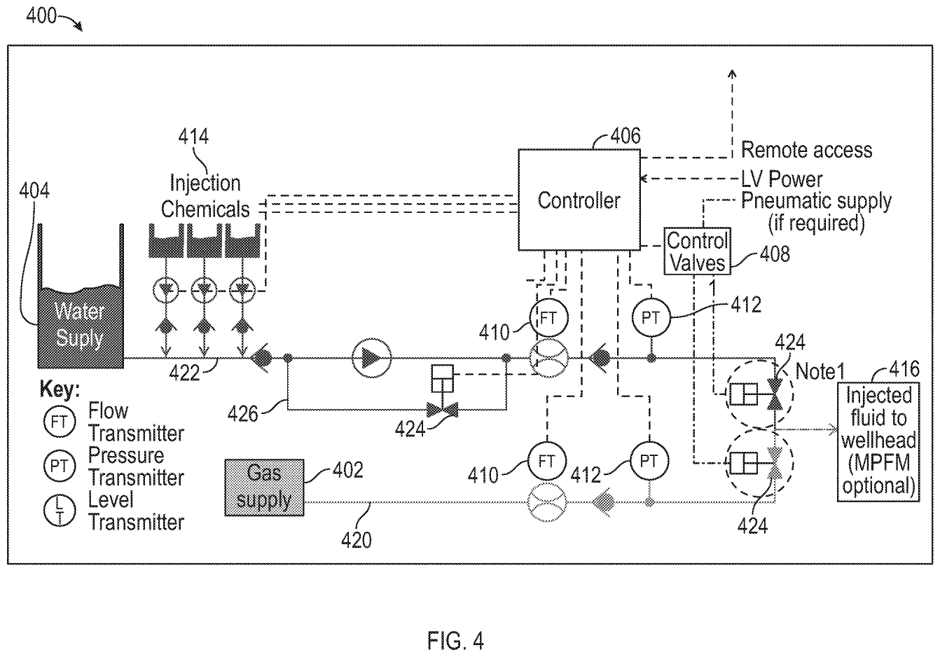

The presently disclosed technology and techniques utilize the injection of various combinations of liquid and gas to reduce surface pressure requirements for conducting Enhanced Oil Recovery processes. FIG. 4 illustrates an example system 400 that utilizes compressed gas 402 and pumped liquid 404 that are variously combined in accordance with aspects of the present disclosure. The system 400 is characterized by a direct supply of gas 402 and liquid 404 to the downhole injection line at a wellhead. In this implementation, compressed gas 402 and pumped liquid 404 can variously be combined, by surface equipment (e.g., skid-loaded), directly into an injection line 416 to the well as depicted in FIG. 4 and as described herein. The system 400 can further include a controller 406, control valves 408, flow transmitters 410, and pressure transmitters 412. The pumped liquid 404 can also be combined with injection chemicals 414 prior to being combined with the combined gas 402.

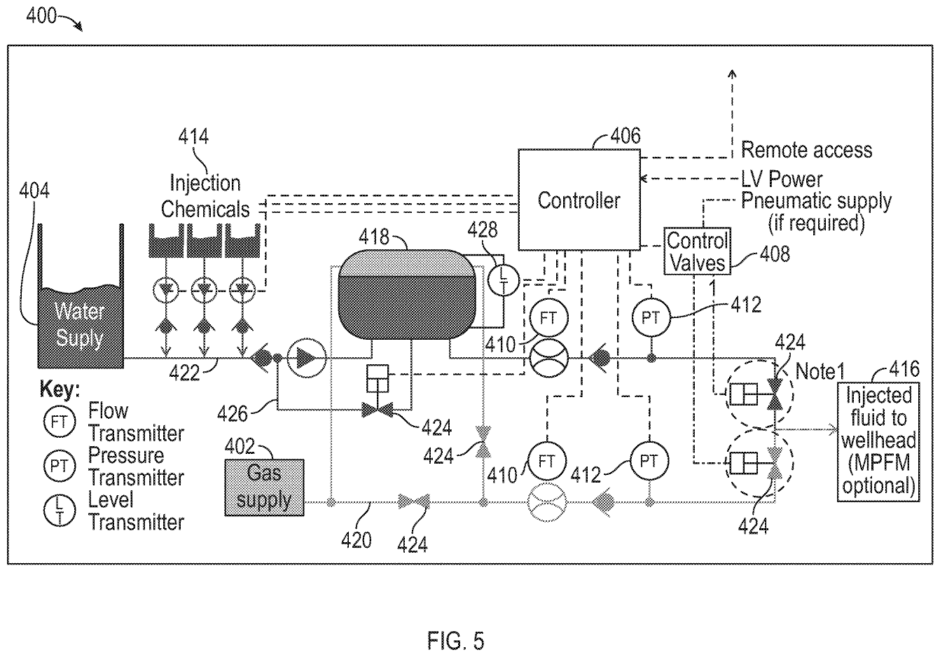

FIG. 5 illustrates an example system 400 that utilizes compressed gas 402 and pumped liquid 404 that are commonly reservoired in a buffer tank 418 in accordance with aspects of the present disclosure. From the buffer tank 418, the gas 402 and liquid 404, in various combined proportions, are injected into the well 416 as depicted in FIG. 5.

In the prescribed process 400, when an applied mixed-phase fluid mixture reaches an injection sand-face downhole, a fluid (e.g., liquid 404/gas 402) mixture enters a fracture system of the reservoir. As this continues, the required injection pressure gradually increases, and responsively, the surface injected fluid density is commensurately increased as the reservoir pressure increases around the injection well.

In a further aspect of the presently disclosed technology, the controller 406 can monitor (advantageously, substantially continuously) the increasing wellbore injection pressure by extracting information from mixed-phase flow models or correlations, or a bottomhole pressure gauge when present. The injection density can be adjusted (e.g., by the controller 406) to maintain a target injection gas-liquid ratio within the constraints of available source gas pressure and capabilities of the system 400.

Further regarding the disclosed system and arrangement 400, in a first aspect, surface equipment can be utilized that is variously arranged and configured to provide an ability to inject a combination of gas 402 and liquid 404 into a subterranean well or wells, at or near the surface, for enhanced oil recovery (EOR). An aspect of the presently disclosed technology is that it requires significantly less surface injection pressure as compared to currently utilized high pressure compressed gas injection for similar enhanced oil recovery procedures. Still further, in addition to utilization in enhanced oil recovery, the technique can also be employed on storage/disposal wells used for subsurface gas/liquid storage or disposal.

The methods and arrangements 400 of the presently disclosed technology permit the use of lower wellhead injection pressure at the surface of a well by taking advantage of hydrostatic pressure derived from the weight of “slugs” of stacked liquid (e.g., variously mixed with gas or spaced apart by gas slugs) established in an injection column created within a well and that result in injection pressures downhole within the well that are greater than the gas pressure applied at the surface. Among other benefits, the system and process 400 require significantly less power when compared with currently utilized high pressure surface gas injection methods. The disclosed technique has utility in onshore oil wells; however, the principle is equally applicable to offshore surface and subsea wells.

In accordance with the teachings of the present disclosure, the pressure and flow rate of each element (e.g., gas 402 and/or liquid 404) can be controlled and monitored (e.g., with the controller 406) during an injection operation. The injection flow regime may be alternating slugs of gas 402 and slugs of liquid 404, or a mixed-phase combination of gas and liquid. Utilizing the buffer tank 418 can be more complex than without one, but utilizing the buffer tank 418 also requires lower peak power requirements and provides better pressure and flow control. A reduced peak power requirement is achieved by incorporating a smaller liquid pump with longer or continuous run time with the buffer tank 418 compared with starting and stopping a larger pump (e.g., without utilizing the buffer tank 418) to provided required volumes on demand. The buffer tank 418 can ensure the source injection pressure of both the gas 402 and liquid 404 are substantially the same and because of which better stability in the system 400 is derived. Hybrid versions of the two arrangements are possible; for example, configuring a gas line 420 to bypass the buffer tank 418 or chemical injection points 414 at more optimum locations in the system 400. The gas bypass option for the buffer tank 418 may be preferred to reduce the possibility of liquid carry over into the gas injection line 420. Another benefit is that the surface equipment can be skid-mounted, or otherwise located proximate the injection well.

On-site, inputs and resources can include: (1) a gas supply with sufficient volume (e.g., flowrate) and pressure to support the injection process at the well of concern; (2) a water supply (e.g., produced water from the field) with sufficient volume (e.g., flowrate) and pressure to supply the liquid pump inlet requirement; (3) electrical power for liquid pump(s) and controls; (4) advantageous chemical additives for the liquid flow stream (e.g., including surfactant), corrosion inhibitor, and hydrate inhibitor; (5) pneumatic supply (if required/available); and (6) internet or other connectivity for remote control and monitoring of the system and process 400.

In some implementations, the presently disclosed system 400 can utilize natural gas supplied at the field. Other gases such as carbon dioxide or nitrogen can also be used for specific applications. If the gas supply 402 in the field has insufficient pressure, an optionally included booster compressor can be used. If the water supply 404 in the field has insufficient pressure to meet the Net Positive Suction Head (NPSH) requirement of the liquid pump, then a booster pump can be provided and utilized. If the water supply 404 in the field has insufficient volume/flow rate to meet the injection requirements, then additional water can be added as long as it is compatible with the reservoir and other aspects of the prescribed EOR procedure. If sufficient electrical power is not available at the well site, additional portable power generation is provided and utilized.

Advantageously, a natural gas or diesel driven portable generator can be supplied where required. Concerning desirable chemical additives 414, surfactant can be utilized to support the EOR process and corrosion inhibitors and hydrate inhibitors can be used as required. The supply of pneumatic pressure will only be required if pneumatic controls are used as an alternative to electrical or hydraulic controls/actuation at the well site.

Regarding system components that support the disclosed system and method 400, the system 400 can include a liquid pump to boost the water and chemical supply to the required injection pressure. The buffer tank 418 of the system 400, which can advantageously be a fabricated pressure vessel, for example, can be 600 #ANSI rated. Process piping is used that is sized, pressure rated, and constructed of appropriate material suited to the specific fluid/well application. Single phase flow meters 410 can be provided on the gas and liquid injection lines 420, 422 to monitor flow. Mixed-phase flowmeters 410 may also be included on the discharge of the system 400 to measure the flowrate of the combined gas/liquid flow 416. Actuable process valves 424 (e.g., open, closed, and/or control valves) are provided to control the process 400. Additional manual valves can be supplied for maintenance, but which are not shown in the Figures. A pump recycle line 426 can be included that facilitates optimal sizing and operation of the pump.

Instruments, such as pressure and level transmitters 412, 428, are provided for monitoring and that are compatible with the selected control system 406. Temperature transmitters are also included where advantageous. The controller 406 for local control of the equipment of the system 400 is provided; typically, a PLC type controller with remote access, but other PC based/DCS/SCADA type controllers can also be used where appropriate. Chemical pumps are provided for pumping surfactant, corrosion inhibitor, and hydrate inhibitor (among others) and which are sized for their duty with correct material selection. Check valves are provided to prevent back flow in the system 400 and relief valves are provided to prevent over pressurization of system 400. Emergency stops for safety are provided locally, and advantageously on the skid arrangement, if utilized. A base/frame/skid/plinth is fabricated for the system 400 to support and transport the active system components, which are modularized for most efficient packaging.

Regarding the system 400 components described herein, the disclosed type of liquid pump drive can take the form of one or more of multiple appropriate drive systems useable as the liquid pump drive in the EOR environment. In one aspect, the pump drive can be an electric motor having constant speed and start and stop control. Alternatively, an electric motor with variable speed drive can be utilized. Still further, an electric motor having constant speed and a torque converter can be implemented. Further still, a gas/dual fuel internal combustion engine can be used as the pump drive. The liquid pump selection can be a base case design that uses a displacement pump or another type of pump can also be used such as multistage centrifugal, twin screw pump and gear pumps.

Regarding the prescribed system components and their assemblage into the disclosed arrangements, dimensions and weight modules (e.g., assembled base/frame/skid/plinth) can be advantageously configured for road transport by truck using ISO shipping container guidelines, typically with the ability to be skid-mounted and fitting inside a standard shipping container for transport to the wellsite.

Example embodiments have been disclosed that are within the scope of this disclosure. Other, different and/or broader embodiments are also within the scope of this disclosure, some of which may include elements of one example embodiment combined with elements of another example embodiment (to the extent combinable), or subsets of elements of one specific example embodiment.

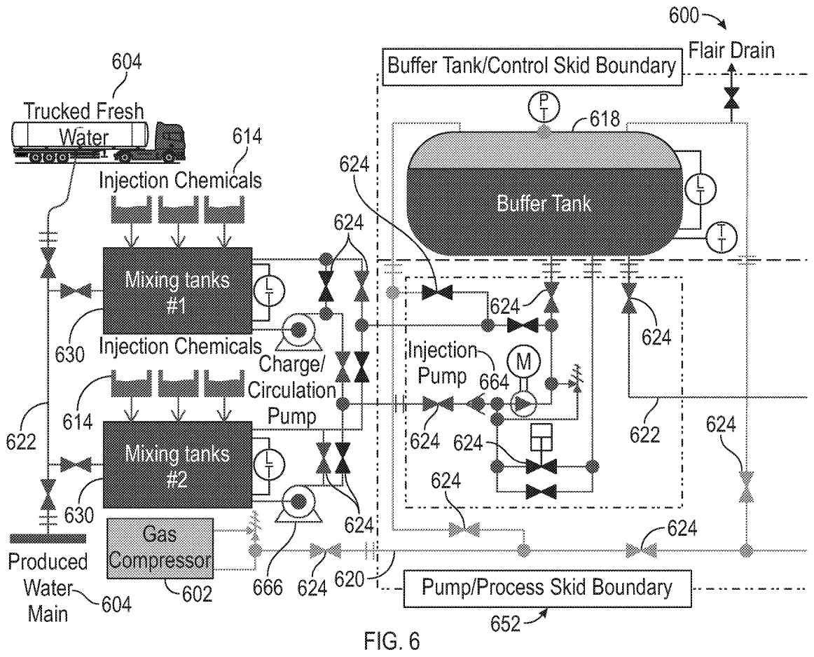

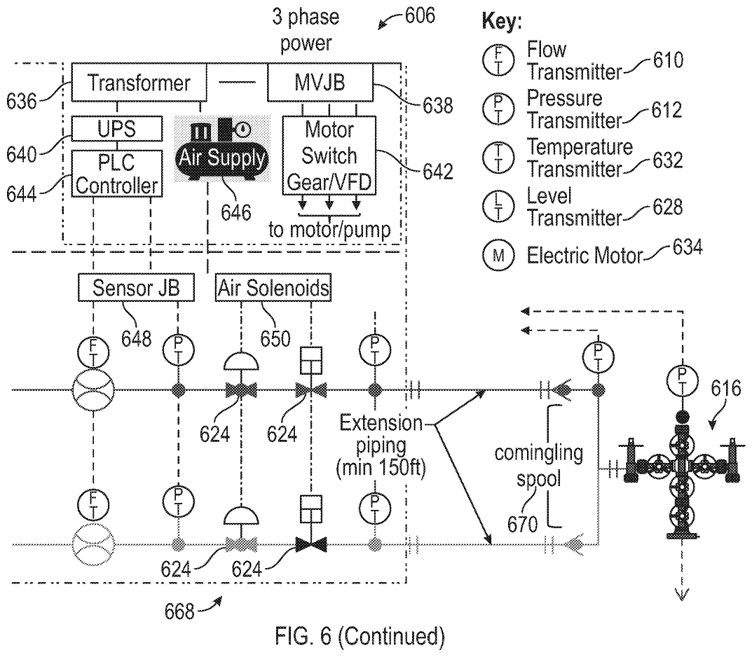

FIG. 6 illustrates an example injection system 600 in accordance with aspects of the present disclosure. In some implementations, the injection system 600 can include a controller system 606, a buffer tank 618, a pump assembly 652, and a fluid dispensing system 668 (e.g., including actuable process valves 624 (e.g., open, closed, and/or control valves) and transmitters (e.g., a flow transmitter 610, a pressure transmitter 612, a level transmitter 628, and a temperature transmitter 632)). The injection system 600 can also be configured to receive liquid 604 via mixing tanks 630 from storage containers or reservoirs such as a trucked fresh water and produced water mains. The mixing tanks 630 can also be configured to mix liquid 604 with injection chemicals 614, as described herein (e.g., 2000 barrels/min). The mixing tanks 630 can further be equipped with level transmitters 628 to determine the level of the mixed solution (e.g., liquid 604 and the injection chemicals 614) within the mixing tanks 630. A charge/circulation pump 666 can also be utilized by the injection system 600 to charge or circulate the mixed solution/liquid 604 out of the mixing tanks 630.

As used in the present disclosure, liquid 604 can include liquid only or liquid mixed with the injection chemicals 614. Valves 624 can also be arranged in the injection system 600 to control the flow of liquid 604 from the mixing tanks 614 and into the buffer tank 618. Liquid 604 can also flow throughout the injection system 600 via liquid lines 622. Gas 602 can also be received by the injection system 600 from a gas compressor or a gas storage unit. Gas 602 can be routed to the buffer tank 618 via gas lines 620 and controlled by the controller system 606 by utilizing the valves 624 distributed throughout the injection system 600. Gas 602 can be directed by the injection system 600 to the buffer tank 618 or directly to an injection well 616.

The pump assembly 652 of the injection system 600 can include an electric motor 634, an injection pump 664, and valves 624 that control the amount, pressure, and velocity of liquid 604 that flows into the buffer tank 618. The injection pump 664 of the pump assembly 652 can be configured to stabilize the buffer tank 618 by continuously filling the buffer tank 618 while the injection system 600 depletes liquid 604 from the buffer tank 618. For example, as the injection system 600 utilizes liquid 604 during the injection process, the amount of liquid 604 in the buffer tank 618 decreases accordingly. As liquid 604 or Gas 602 is depleted from the buffer tank 618, the pressure within the buffer tank 618 will fluctuate accordingly. To counter this, as liquid 604 is expended from the buffer tank 618, the injection pump 664 can correspondingly inject more liquid 604 into the buffer tank 618 until a desired amount or pressure is reached.

The buffer tank 618 of the injection system 600 can be configured to store liquid 604 and Gas 602 at substantially equal pressure, but various relative quantities. For example, the controller system 606 can control the valves, the pump assembly 652, and gas compressor to migrate a predetermined amount of liquid 604 and Gas 602 into the buffer tank 618. The buffer tank 618 can also be configured to utilize a level transmitter 628 to notify the injection system 600 of the current level of liquid 604 and/or gas 604 within the buffer tank 618. The buffer tank 618 can further utilize a temperature transmitter 632 to determine the temperature of the liquid 604 stored inside the buffer tank 618. Though the buffer tank 618 is shown in FIG. 6 as having a temperature transmitter 632 proximate to the liquid 604, a temperature transmitter 632 (e.g., a temperature sensor) can be positioned within the buffer tank 618, proximate to the gas 604 to measure the temperature of the gas 604. The buffer tank 619 of the injection system 600 can further be configured to include a pressure transmitter 612 to determine the pressure of the liquid 604 and the Gas 602.

The controller system 606 of the injection system 600 can include a transformer 636, a medium voltage junction box (MVJB) 638 (e.g., a MVJB with 3-phase power, 100 KVA, 3PH, 480V), an uninterruptible power source (UPS) 640, a motor switch gear/variable frequency drive (VFD) 642, a programmable logic controller (PLC) controller 644, and an air supply 646 that can be configured to control air solenoids 650, which actuate valves 624. The controller system 606 can further receive data from sensors 648 relating to the liquid 604 in the liquid line 622 and the Gas 602 in the gas line 620. The sensors 648 can include flow transmitters 610 (e.g., which determines the flow rate of liquid 604 in the liquid line 622 and Gas 602 in the gas line 620), and pressure transmitters 612 (e.g., which determines the pressure of liquid 604 in the liquid line 622 and Gas 602 in the gas line 620).

The controller system 606 can further include various modes of operation including a monitoring mode, a maintenance mode, an operating mode, and an engineering mode. The monitoring mode can include monitoring all of the transmitters 610, 612, 632, 628 and providing local and remote monitoring services. Maintenance mode can include filling the buffer tank 618 with liquid 604, circulating liquid 604 back into the mixing tank 630, and performing a leak test. Operating mode can include fully automating operation of the injection system 600 to provide alternating flow from Gas 602 and liquid 604 skid outlets with full monitoring of sensors and pump operation, start/stop injection functions, tuning parameters (e.g., tuning Gas 602 and liquid 604 slug durations and flow rates), utilizing alarm definitions (e.g., HiHi alarm, 80% buffer tank level, pump stops on ascending level; Hi alarm, 70% buffer tank level, recycle valve opens on ascending level, pump starts on descending level; normal operating level, 60% buffer tank level; Lo alarm, 30% buffer tank level, gas and liquid discharge valves shut; and LoLo alarm, 20% buffer tank level, pump shutdown), and permissives (e.g., at startup, determining that the buffer tank level is within range, gas supply pressure is within range, valves 624 are in their correct positions, low buffer tank levels, low discharge pressure for Gas 602 and liquid 604, and low gas supply pressures). Engineering mode can include being password protected, providing local and remote access, providing full manual control of control functions, modifying set points and alarms, and providing emergency shutdown functions.

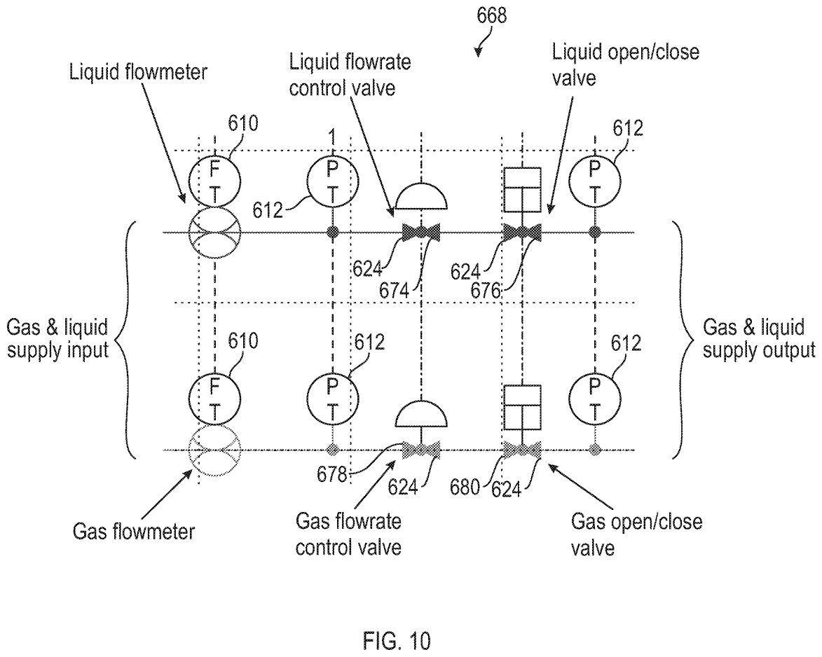

By determining the flow rate and pressure of liquid 604 in the liquid line 622 and Gas 602 in the gas line 620, the controller system 606 of the injection system 600 can compare the measured flow and pressure rates to then be adjusted accordingly by the fluid dispensing system 668. For example, if the measured flow and pressure rates are too high, the fluid dispensing system 668 of the injection system 600 can activate the air solenoids 650 to close the valves 624, thereby lowering the flow and pressure rates, until desired flow and pressure rates are reached. Referring to FIG. 10, the fluid dispensing system 668 can include flow rate transmitters 610 (e.g., flow rate sensors), pressure transmitters 612 (e.g., pressure sensors), and valves 624. The valves 624, as shown in FIG. 10, can include a liquid flow rate control valve 674, a liquid on/off valve 676, a gas flow rate control valve 678, and a gas on/off valve 680. The liquid flow rate control valve 674 can control the flow rate of the liquid 604 in the liquid line 622 of the injection system 600. The gas flow rate control valve 678 can control the flow rate of the Gas 602 in the gas line 620 of the injection system 600. The liquid on/off valve 676 can be configured to open or close the liquid line 622 of the injection system 600. The gas on/off valve 680 can be configured to open or close the gas line 620 of the injection system 600. In some implementations, the liquid on/off valve 676 and the gas on/off valve 680 can alternate their respective positions. For example, when the controller system 606 opens the liquid on/off valve 676, the controller system 606 closes the gas on/off valve 680. Also, when the controller system 606 closes the liquid on/off valve 676, the controller system 606 opens the gas on/off valve 680. As shown in FIG. 6, air solenoids 650 may be utilized to control the liquid flow rate control valve 674, the liquid on/off valve 676, the gas flow rate control valve 678, and the gas on/off valve. It is also envisioned that other types of actuators and controllers (e.g., pneumatic, electrical, and mechanical actuators and controllers) can control the opening and closing positions of the liquid flow rate control valve 674, the liquid on/off valve 676, the gas flow rate control valve 678, and the gas on/off valve.

Examples of liquid rates for a 7×2⅞ inch annulus, with a 5.373 inch eq. inner diameter (ID), for 800 psig and 600 psig are provided below in Tables 1 and 2, respectively:

TABLE 1
800 psig surface pressure, 3 MMscf/day

| | | | Mixture | Liquid | | |
|---|---|---|---|---|---|---|
| | | Mixture | Velocity | During | | |
| Liquid | Liquid | Velocity | 30 inch | Slug | Slug | Bubble |
| Rate | Rate | in Well | ID Pipe | Injection | Injection | Injection |
| (BWPD) | (gpm) | (ft/sec) | (ft/sec) | (gpm) | (sec) | (sec) |
| 1.492 | 43 | 4.83 | 15.6 | 341 | 9.5 | 64 |
| 2.172 | 63 | 5.11 | 16.5 | 360 | 9.0 | 44 |
| 2.853 | 83 | 5.39 | 17.4 | 380 | 8.5 | 30 |

TABLE 2
600 psig surface pressure, 2 MMscf/day

| | | | Mixture | Liquid | | |
|---|---|---|---|---|---|---|
| | | Mixture | Velocity | During | | |
| Liquid | Liquid | Velocity | 30 inch | Slug | Slug | Bubble |
| Rate | Rate | in Well | ID Pipe | Injection | Injection | Injection |
| (BWPD) | (gpm) | (ft/sec) | (ft/sec) | (gpm) | (sec) | (sec) |
| 1.000 | 30 | 4.17 | 13.5 | 295 | 11.0 | 99 |
| 4.000 | 117 | 5.4 | 17.4 | 382 | 8.5 | 19 |

The liquid slug can include a minimum stable slug upward flow of 32-64D, with a 46 ft. slug length in one embodiment being approximately 103D. The gas bubble can be determined by a material balance.

The injection system 600 can further include a comingling spool 670 that can be configured to mix/alternate liquid 604 and Gas 602 that is then directed to the wellhead 616. Pressures at the comingling spool 670 and the wellhead 616 can be measured by utilizing pressure transmitters 612.

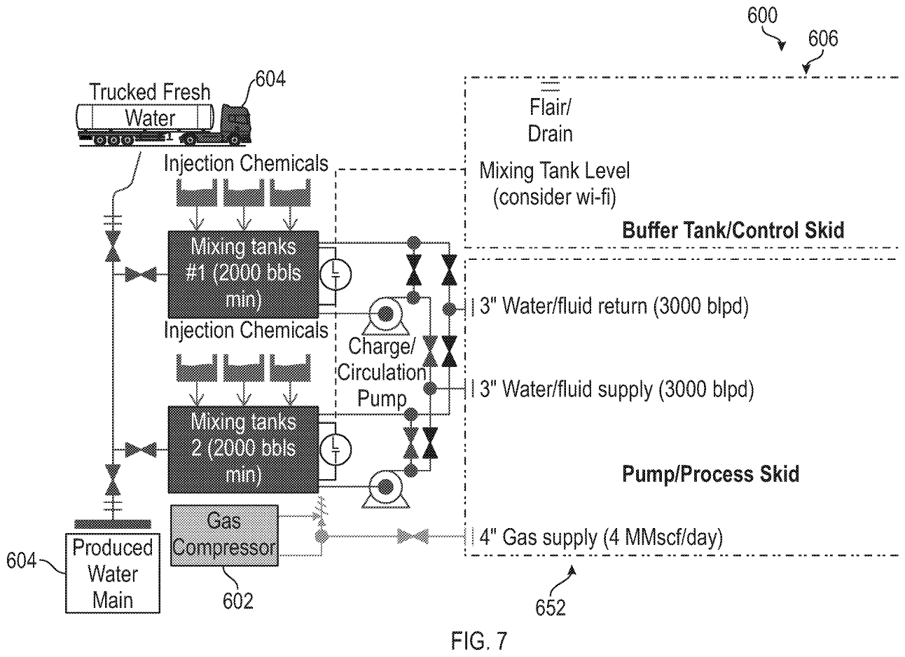

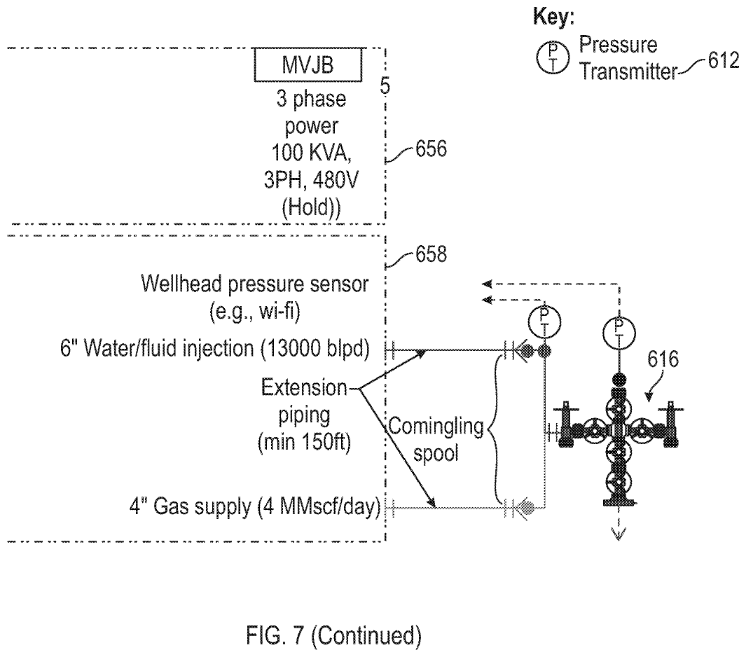

FIG. 7 illustrates an example of the injection system 600 of FIG. 6 along with corresponding skids 656, 658 in accordance with aspects of the present disclosure. For example, the skid 656 can be configured to include the buffer tank 618 and the controller system 606 of the injection system 600, while the skid 658 can be configured to include the pump assembly 652 and the fluid dispensing system 668 of the injection system 600. In some implementations, the level of mixed solution/liquid in the mixing tanks 630 (e.g., measured by the level transmitter 628) can be transmitted (e.g., Wi-Fi, Bluetooth, etc.) to the controller system 606 of the injection system 600 in the skid 656.

The pump assembly 652 of the injection system 600 can include piping (e.g., 4 inch) and utilize the injection pump 664 and valves 624 to facilitate water/fluid return (e.g., 3000 blpd) and water/fluid supply (e.g., 3000 blpd). The pump assembly 652 can further include piping (e.g., 6 inch) for water/fluid injection (e.g., 13,000 blpd) to the comingling spool 670. The pump assembly 652 of the injection system 600 can further include 4 inch piping to have access to a gas supply (e.g., Gas 602 from a gas compressor) (4 MMscf/day) and to have provide Gas 602 (e.g., 4 MMscf/day) to the comingling spool 670. In some implementations, wellhead pressure measured at the wellhead 616 by pressure transmitter 612 can be received by pump assembly 652/fluid dispensing system 668 of skid 658.

FIG. 8 illustrates an example of the injection system 600 of FIG. 6 along with a mixer 654 and FIG. 9 illustrates an example mixed-phase injection mode in accordance with aspects of the present disclosure. Mixer 654 of the injection system 600 can alternate slugs of liquid 604 and Gas 602, or premix the liquid 604 and Gas 602 prior to being injected into the wellhead 616. The injection system 600 can further include a mixed-phase meter 672 between the mixer 654 and the wellhead 616 to measure flow rates of the liquid 604 and Gas 602. The mixed-phase meter 672 can be a specialized flow meter that is configured to measure the flow rate of the premixed liquid 604 and Gas 602. During the mixed-phase injection mode, as shown in FIG. 9, the injection system 600 can include and utilize the mixer 654 and/or the mixed-phase meter 672.

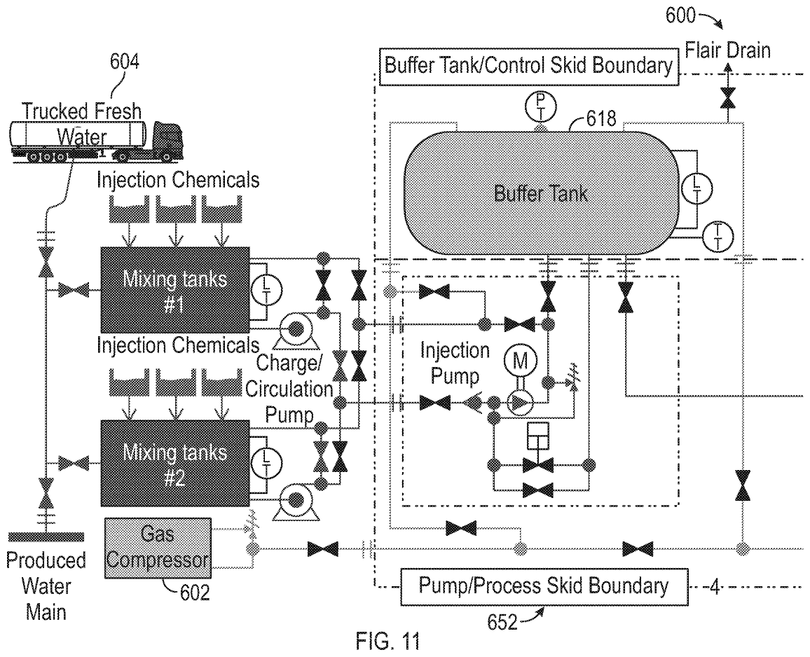

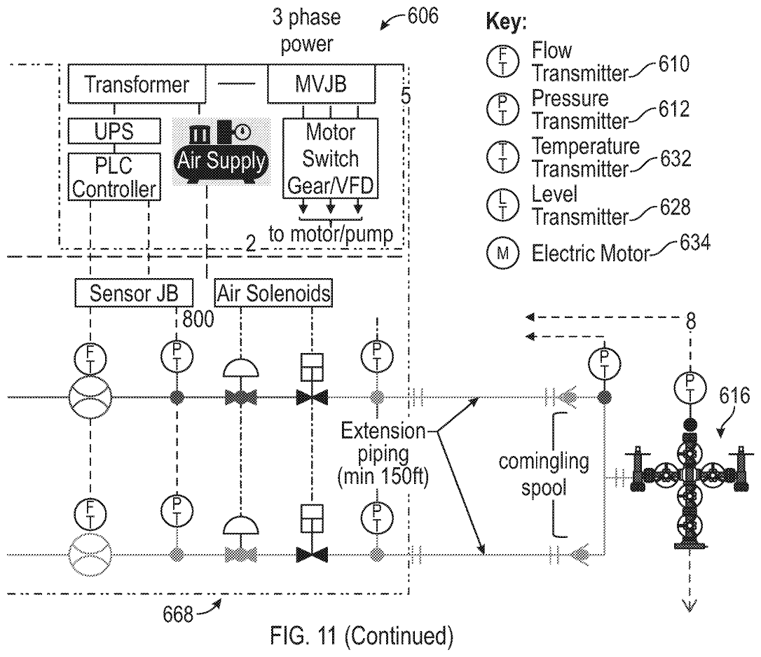

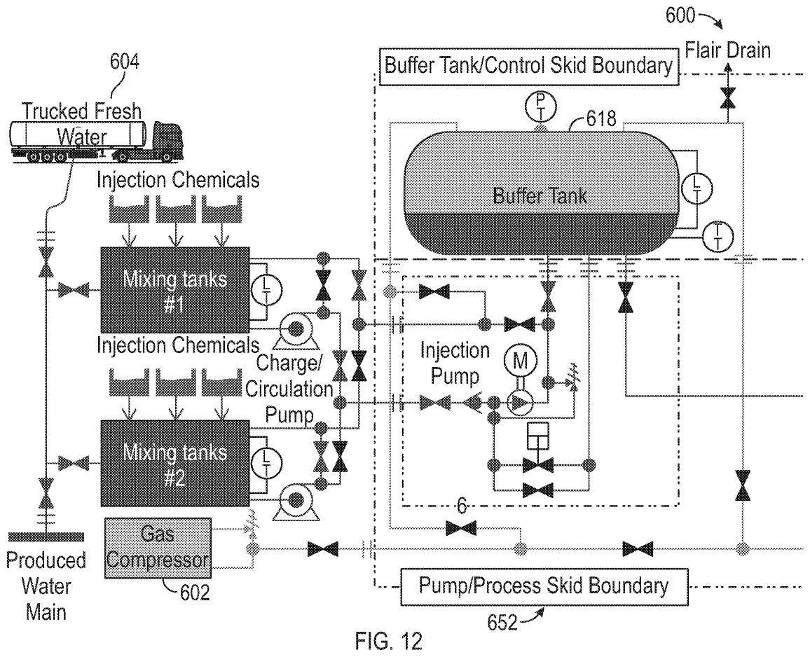

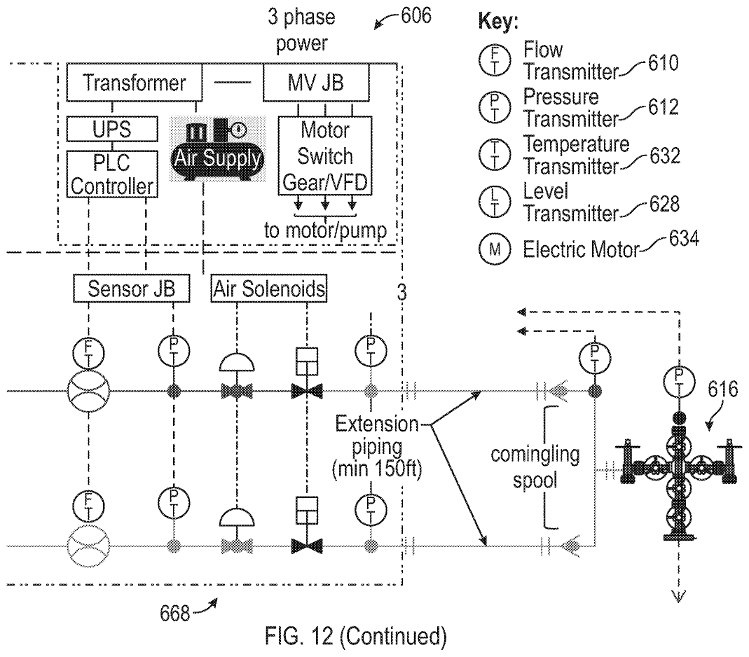

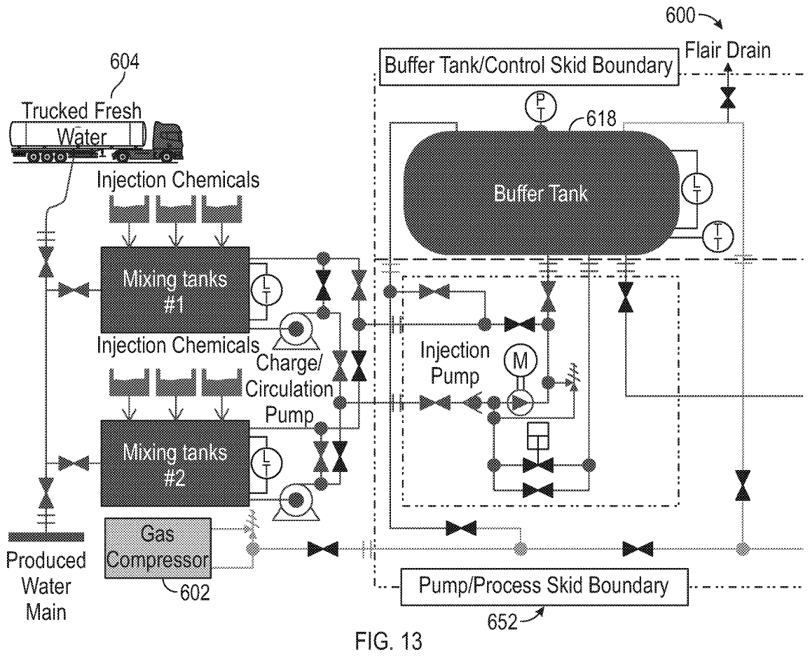

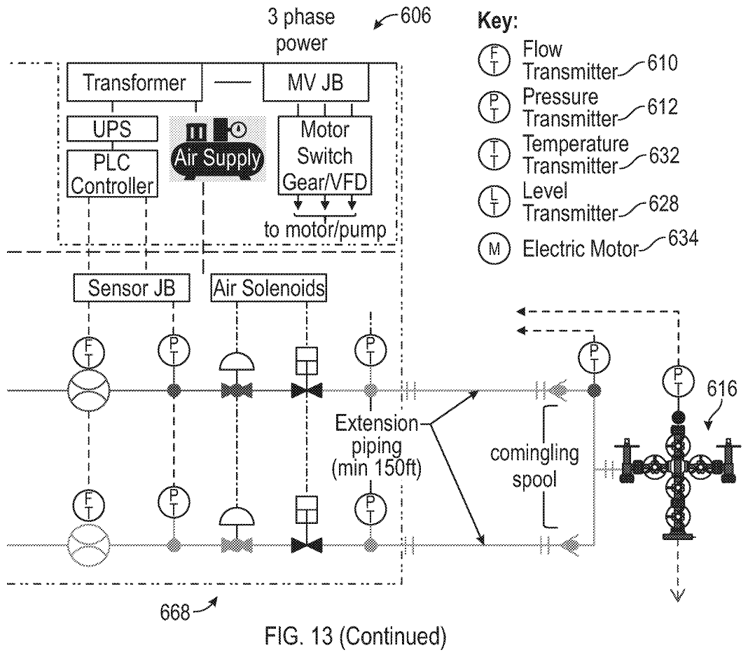

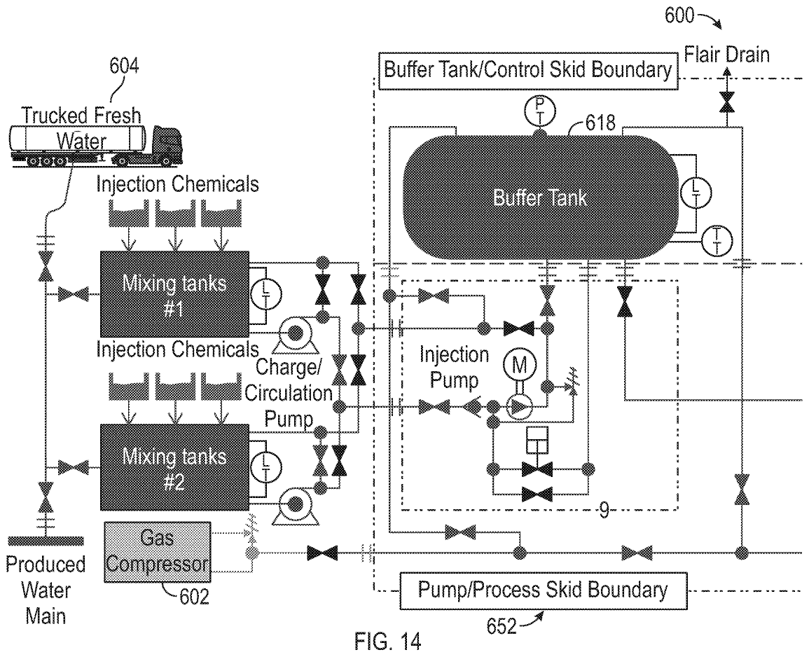

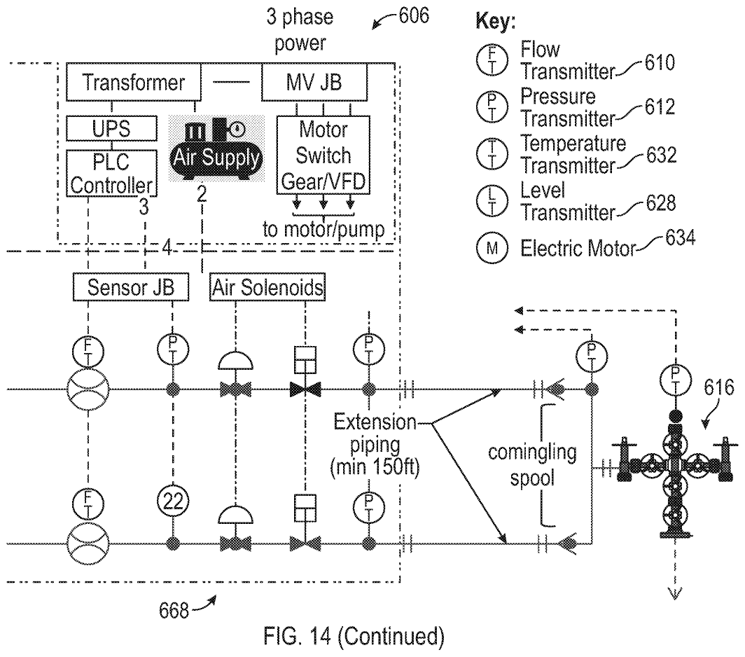

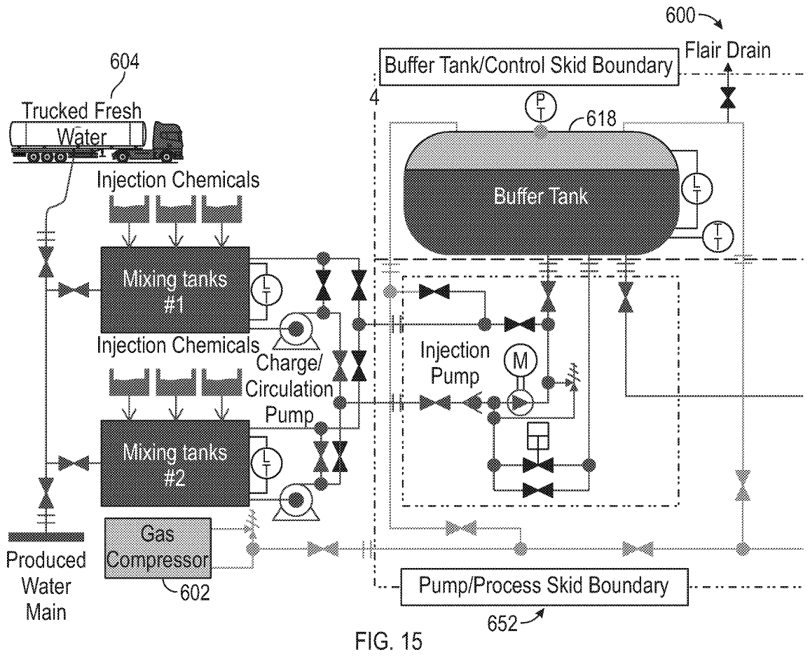

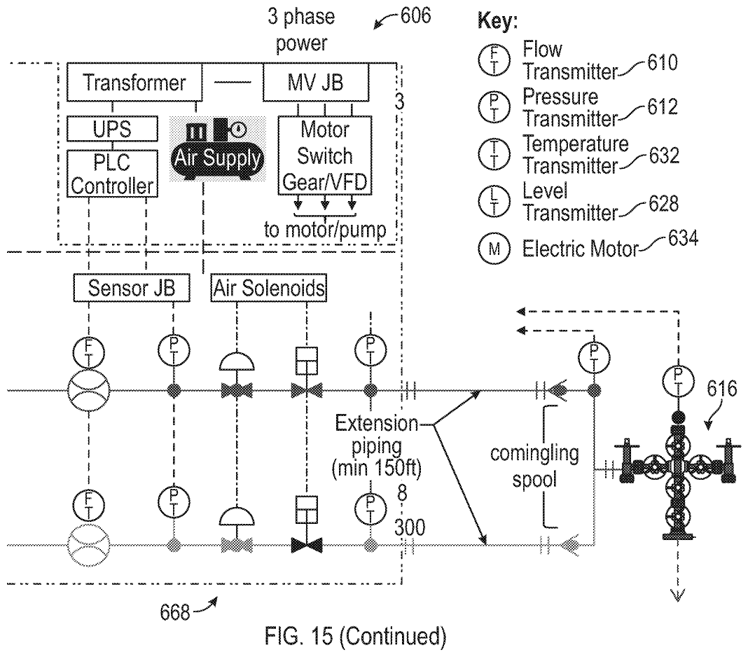

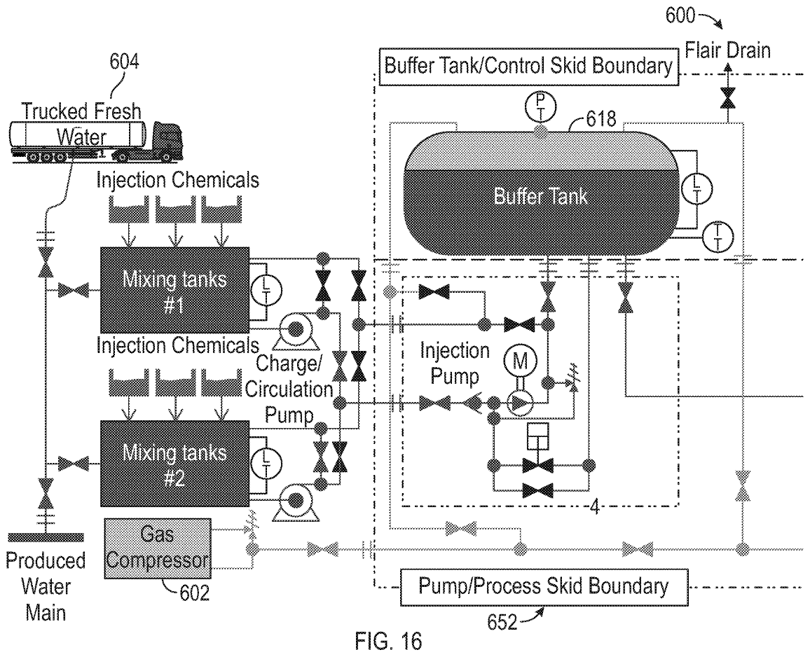

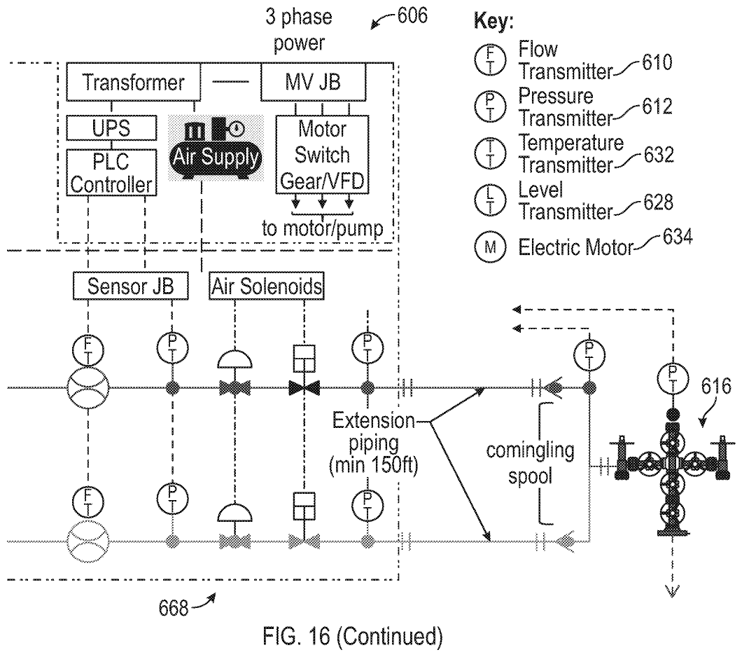

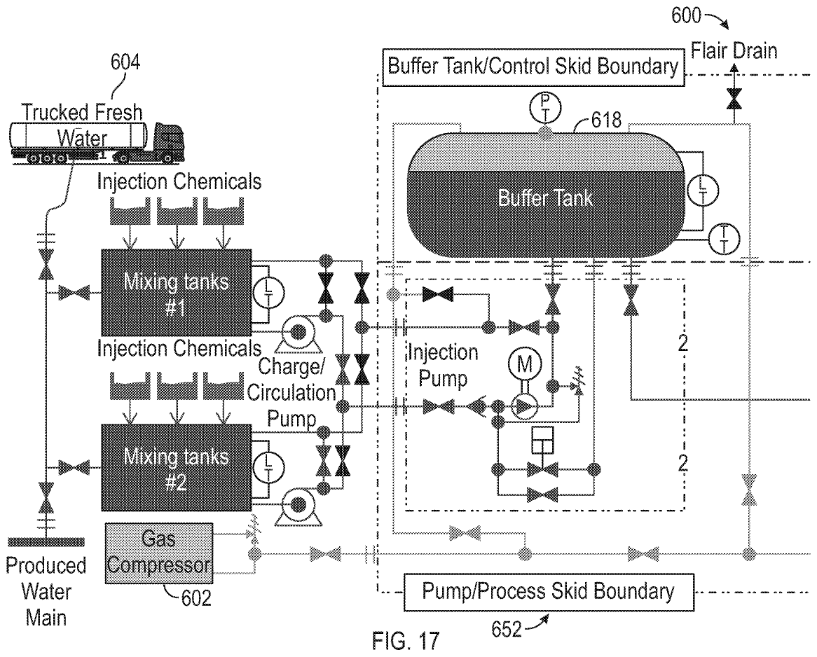

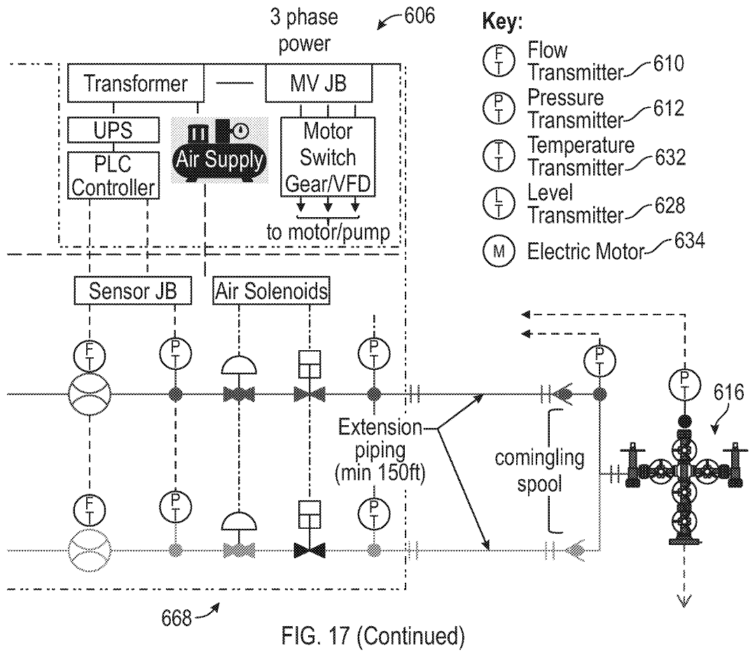

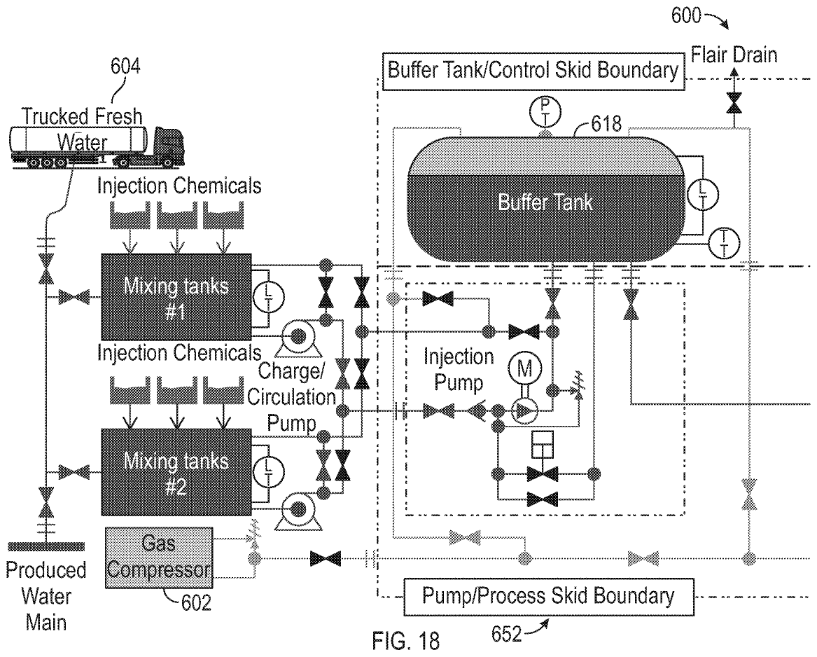

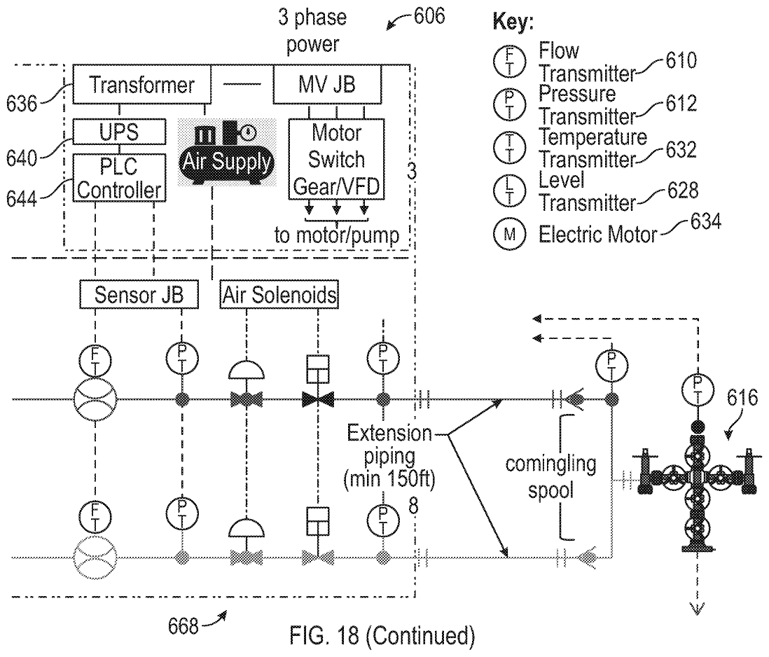

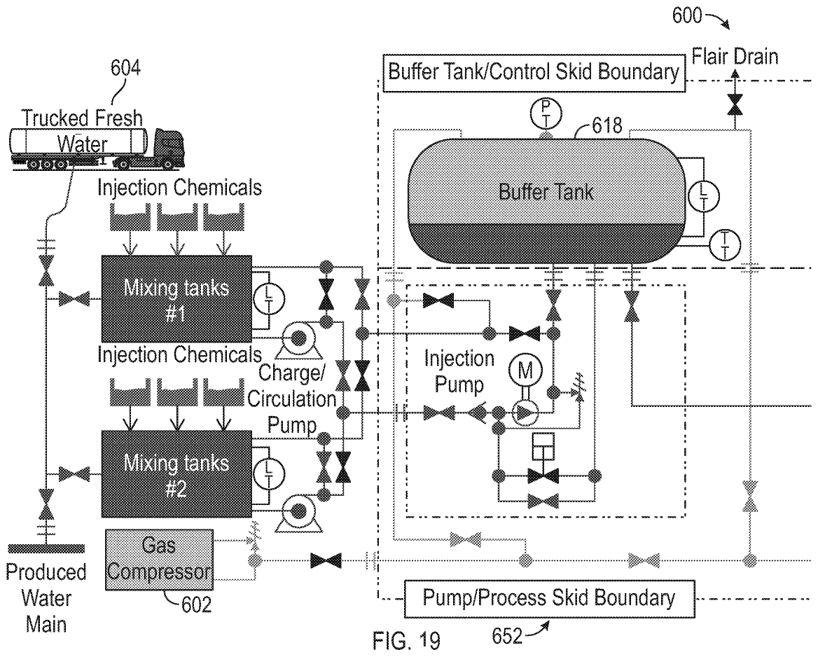

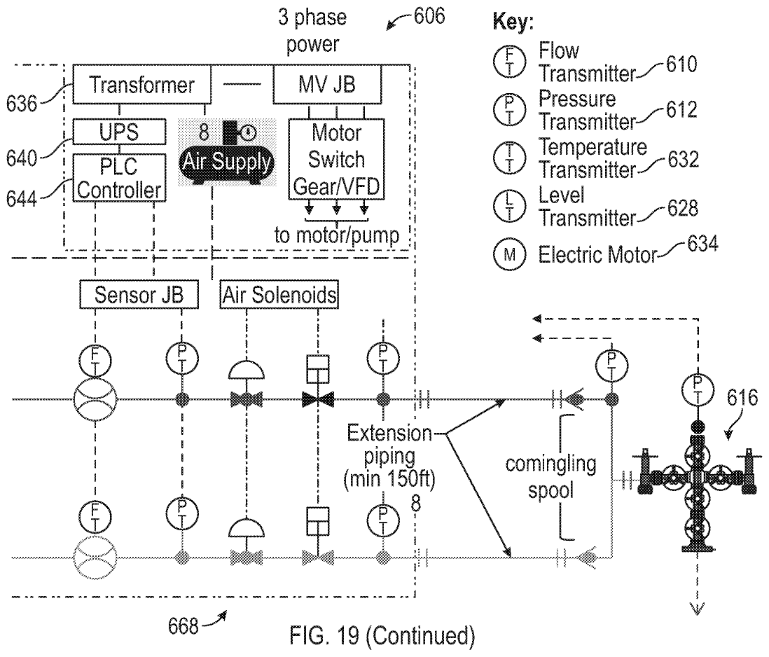

FIG. 11 to FIG. 19 illustrate example sequences of the injection system 600 of FIG. 6 in accordance with aspects of the present disclosure. FIG. 11 illustrates an example pre-startup configuration of the injection system 600, which can include an empty buffer tank 618 and preparing liquid 604 and Gas 602 supplies. FIG. 12 illustrates an example buffer tank fill configuration of the injection system 600, which can include filling the buffer tank 618 with liquid 604. FIG. 13 illustrates an example buffer tank circulate configuration of the injection system 600, which can include filling the buffer tank 618 to the maximum capacity of the buffer tank 618. FIG. 14 illustrates an example leak test configuration of the injection system 600, which can be utilized to determine whether a liquid leak is present in the injection system 600, as the injection system 600 is completely filled with liquid 604. FIG. 15 illustrates an example normal operation—water injection cycle configuration of the injection system 600, which can include injecting liquid 604 into the wellhead 616. FIG. 16 illustrates an example normal operation—gas injection cycle configuration of the injection system 600, which can include pressurizing the buffer tank 618 with Gas 602 and injecting Gas 602 into the wellhead 616. FIG. 17 illustrates an example normal operation-water injection cycle-pump in recycle configuration of the injection system 600, which can include injecting liquid 604 into the wellhead 616. FIG. 18 illustrates an example gas vent configuration of the injection system 600, which can include stopping the pump assembly 652. FIG. 19 illustrates an example buffer tank emptying configuration of the injection system 600, which can include draining the buffer tank 618.

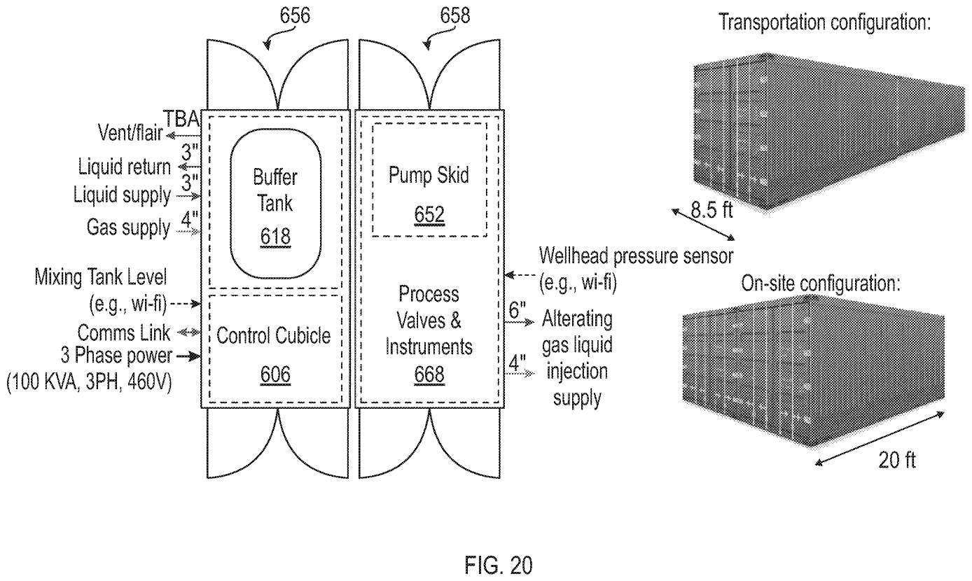

FIG. 20 illustrates example skid configurations of the injection system 600 of FIG. 6 in accordance with aspects of the present disclosure. The skid 656 can include the buffer tank 618 and the controller system 606, along with a vent/flair, a liquid return outlet (e.g., 3 inches), a liquid supply inlet (e.g., 3 inches), a gas supply inlet (e.g., 4 inches), a communications link, and a power connection (e.g., a 3-phase power with 100 KVA, 3PH, and 460V). The skid 658 can include the pump assembly 652 and the fluid dispensing system 668, along with alternating Gas 602 and liquid 604 injection supply outlets (e.g., 4 inches and 6 inches, respectively). FIG. 20 further illustrates transportation and on-site configurations of skids 656, 658.

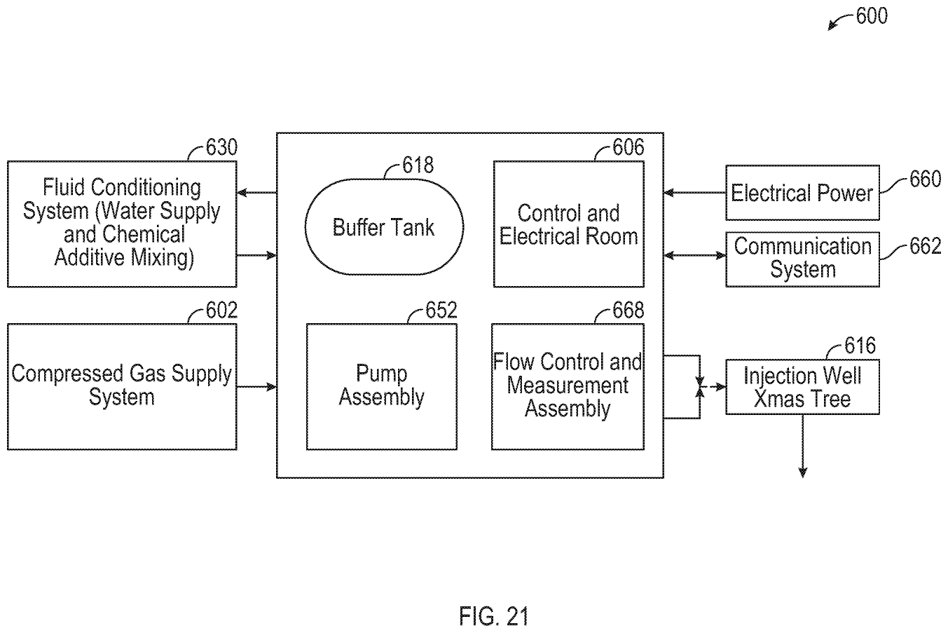

FIG. 21 illustrates an example of the injection system 600 of FIG. 6 along with electrical power and a communication system in accordance with aspects of the present disclosure. Along with the mixing tanks 630 (e.g., a fluid conditioning system that mixes liquid 604 and the chemical additives 614), the compressed gas supply system 602, the buffer tank 618, the controller system 606, the pump assembly 652, and the fluid dispensing system 668, the injection system 600 can further include external electrical power 660 and a communication system 662 (e.g., 5G, Wi-Fi, Bluetooth, Ethernet, etc.) to transmit and receive data relating to the injection system 600 (e.g., measured by flow transmitters 610, pressure transmitters 612, temperature transmitters 632, and level transmitters 628).

In some implementations, injection system 600 can include a downward slug flow generated by alternating liquid and gas injection into a pipe or annular flow path. Generating an artificial slug flow regime can delivery hydrostatic pressure to the bottom of the flow path under high gas volume fraction conditions where a natural flow pattern would exhibit separated flow. That is, for separated flow, liquid can drop through a continuous gas phase and a gas gradient would be observed at the bottom of the flow path. The generated slug flow provides for the delivery of gas and liquid to the bottom of the flow path with a lower surface injection pressure than would otherwise be possible.

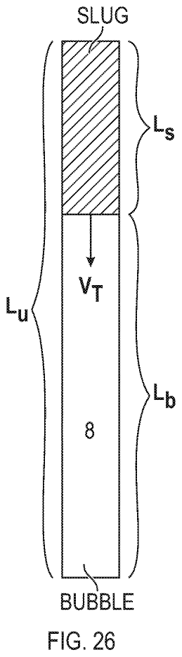

FIG. 26 illustrates an example slug unit including a liquid slug and gas bubble (also referred to as a gas slug). For downward two-phase flow, the slug has a length Lₛ and is moving at a velocity v_{T}, while the gas bubble has a length L_{b}. The slug unit length (Lᵤ) is calculated by:

$$Lu = Ls + Lb$$

The model sets the length of the generated slug length and the bubble length is calculated using a material balance with the average injection flow rates of both liquid and gas. The liquid slug can be all liquid or can contain entrained gas providing a liquid holdup (e.g., volume fraction) in the slug, Hₛ and a liquid holdup in the gas bubble, H_{b}.

For upward flow in a pipe, a minimum stable slug length between 32-64d has been observed, where d is the effective diameter of the flow path. For downward flow, the generated slug length can adjusted as needed to deliver the EOR process to the reservoir and may be greater than the minimum slug length (Lₛ) in the vertical flow path:

$${L}_{s} > 64 d$$

The selection of the slug length sets several important parameters for the slug generation process. This includes the length of time for liquid flow and the magnitude of pressure increase at the inlet of the downward flow path. The length of time for passage for the liquid slug tₛ) is provided by:

$${t}_{s} = \frac{{L}_{s}}{{v}_{T}}$$

Where v_{T} is the translational velocity of the liquid slug. Considering only the hydrostatic pressure losses associated with adding a liquid slug to the downward vertical flow stream, the following is provided:

$$Δ {P}_{s} = {γ}_{L} {L}_{s}$$

Where γ_{L} is the pressure gradient of the injected liquid phase and when the liquid slug contains no embedded gas. If there is a gas present in the liquid slug, then

$$Δ {P}_{s} = {γ}_{L} {L}_{s} {H}_{s}$$

Given a set slug length (Ls), the bubble length (L_{b}) is calculated using a material balance with the average gas and liquid injection rates:

$${L}_{b} = {L}_{s} ( \frac{{v}_{SG}}{{v}_{T} - {v}_{SG}} ) = {L}_{s} ( \frac{{v}_{SG}}{{v}_{SL}} )$$

The length of time for passage for the gas bubble (t_{b}) is provided by:

$${t}_{b} = \frac{{L}_{b}}{{v}_{T}}$$

Where v_{T} is the translational velocity of the liquid slug.

For upward and vertical slug flow, the liquid slug travels at a translational velocity (v_{T}) higher than the mixture flow velocity (vₘ) as the nose of the slug is located near the center line of the pipe where the fluid is traveling approximately 1.2 times the average velocity. Also, the drift velocity of a Taylor bubble, v_{TB}, in a static liquid is superimposed on the mixture velocity. For low viscosity fluids:

$${v}_{T} = 1.2 {v}_{m} + {v}_{T B} where ,$$

$${v}_{m} = {v}_{S L} + {v}_{S G}$$

$${v}_{S L} = \frac{{Q}_{L}}{{A}_{P}}$$

$${v}_{S G} = \frac{{Q}_{G}}{{A}_{P}}$$

For annular flow paths the annular flow area can be represented as:

$${A}_{p} = {A}_{e q} = \frac{π}{4} [ {ID}_{c}^{2} - {OD}_{t}^{2} ]$$

Where ID is the casing internal diameter and ODₜ is the tubing external diameter. An equivalent or effective diameter of the annular flow path, dₑ, can be calculated by:

$${d}_{e} = \sqrt{{ID}_{c}^{2} - {OD}_{t}^{2}}$$

and the hydraulic diameter, dₕ, by

$${d}_{h} = \frac{{ID}_{c}^{2} - {OD}_{t}^{2}}{{ID}_{c} - {OD}_{t}} .$$

Provided below is a table showing values for flow area, equivalent velocity, and hydraulic diameter for injection flow paths in unconventional Huff & Puff applications.

| | 7-inch | 5½-inch | 7 × | 7 × | 5½ × | 5½ × | 3.5-inch | 2.875-inch | 2.375-inch |
|---|---|---|---|---|---|---|---|---|---|
| Wellbore Flow | 32# | 23# | 2⅜ | 2⅞ | 2⅜ | 2⅞ | 9.3# | 6.5# | 4.7# |
| Hydraulic (in) | 6.094 | 4.67 | 3.719 | 3.219 | 2.295 | 1.795 | 2.992 | 2.441 | 1.995 |
| Eqivalent ID (in) | 6.094 | 4.67 | 5.612 | 5.373 | 4.021 | 3.680 | 2.992 | 2.441 | 1.995 |
| Flow Area (ft²) | 0.2026 | 0.1189 | 0.1718 | 0.1575 | 0.0882 | 0.0739 | 0.0488 | 0.0325 | 0.0217 |

For downward slug flow, there is no Taylor bubble rise velocity to superimpose. As such, the slug translational velocity is the mixture velocity:

$${v}_{T} = {v}_{m}$$

The downward flow is assumed to be fully turbulent. That is when the Reynolds number, Re, is greater than 10,000, where Re is defined below:

$$R e = \frac{{ρ}_{m} {v}_{m} d}{{μ}_{m}}$$

In addition, the effective downward velocity may be sufficient to overcome buoyance forces that can cause the gas to move upward, rather than downward, in the pipe or annular space. The highest upward velocity in a pipe is found in large Taylor bubble rather than small bubbles. As such, the downward mixture velocity must be greater than the upward, buoyance-driven, Taylor bubble velocity. The velocity of the Taylor bubble is provided by:

$${V}_{T B} = 0.35 \sqrt{g d}$$

As injected fluids is a low viscosity Newtonian fluid (e.g., water or brine), this equation describes the Taylor velocity in the slug generating process.

For generated slug flow, the gas density is expected to be significant when compared with liquid and this can be accounted for using the following equation:

$${v}_{T B} = 0.35 \sqrt{g d ( \frac{Δ ρ}{{ρ}_{L}} )}$$

Therefore, for delivery of this process:

$${v}_{m} > {v}_{T B}$$

Pressure increases in downward flow of a mixed-phase gas-liquid stream is dominated by the gravitation pressure gradient and the frictional pressure gradient, which is less except at high velocities. Flow created slug flow gravitation and frictional pressure increases can be calculated by:

$${( Δ {P}_{g r a v} )}_{s} = {ρ}_{L} g {L}_{s}$$

The frictional pressure drop is provided by:

$${( Δ {P}_{f r i c} )}_{s} = 2 ( \frac{{f}_{L} {ρ}_{L} {v}_{s}^{2}}{d} ) {L}_{s}$$

The gravitation pressure increase in the gas bubble regions is provided by:

$${( Δ {P}_{g r a v} )}_{b} = {ρ}_{G} g {L}_{b}$$

The frictional pressure losses in the gas bubble are small and difficult to determine. As such, these are neglected.

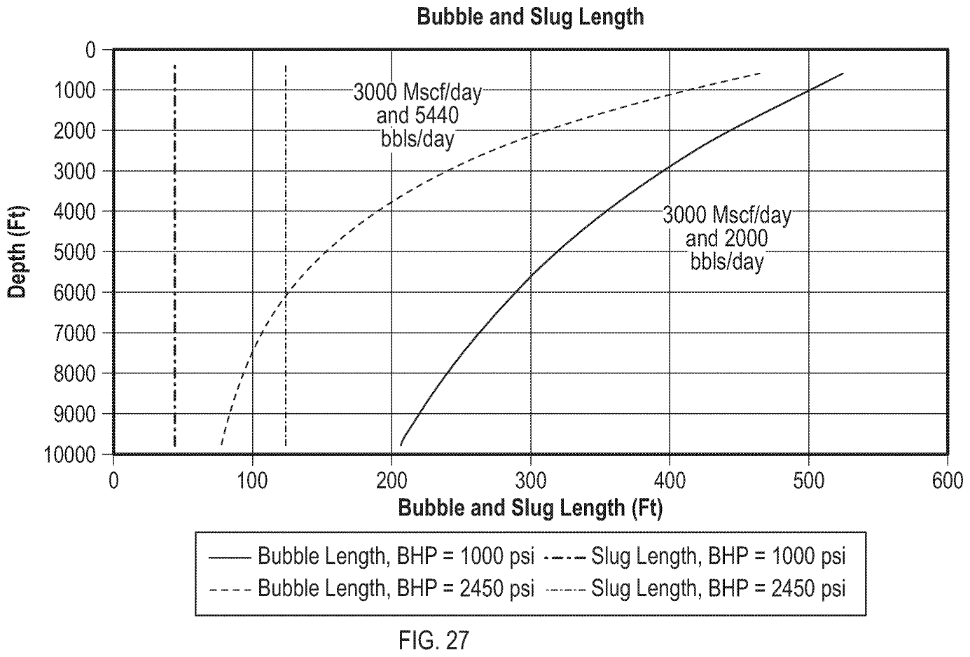

Multiple slug units will be distributed in the vertical flow path to create the pressure needed at the bottom before entry into the reservoir. As slug units move downward, pressure increases and the gas in the gas bubble region is compressed. This results in both increased density of the gas, but also a dramatic decrease in the length of the bubble region. Given below are example profiles of slugs in a vertical downward pipe. For example, as shown in FIG. 27 to reach a P_{bh}=1000 psi, an average liquid rate of 2000 bbls/day is needed and Lₛ=~ 46 ft. To reach a P_{bh}=2450 psi, an average liquid rate of 5450 bbls/day is needed and slug length has increased to Lₛ~125 ft. As these two examples have different pressure “end points,” the bubble lengths decrease from initial lengths over 500 ft to 210 and 80 ft, depending on the pressure. In both examples, the surface injection pressure was 300 psig.

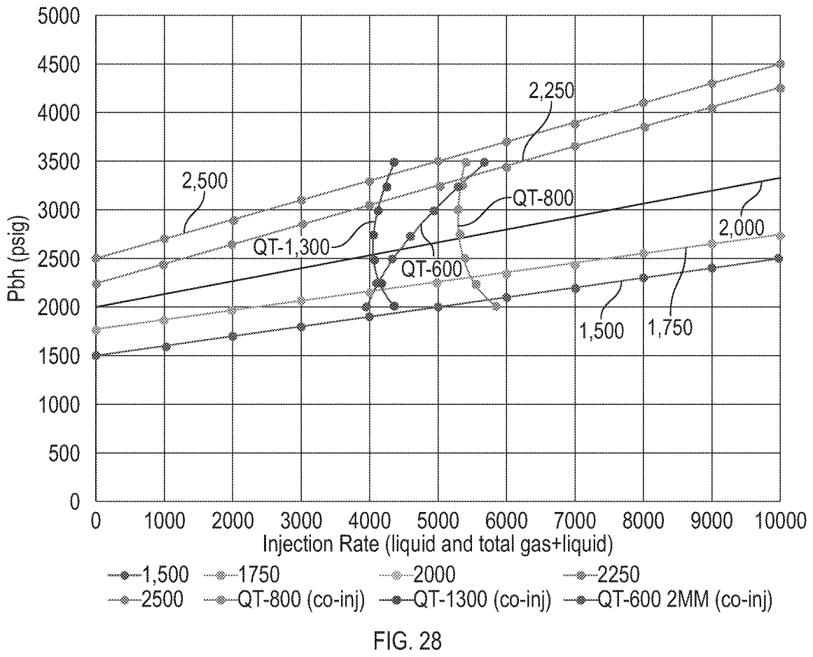

Systems analysis is a method that can be used to estimate the bottomhole injection rates and pressure for the EOR injection process described herein. Systems analysis consists of plotting the reservoir Inflow Performance Relationship (IPR) curve/line and the Tubing Curve. The intersection of these two curves defines the operation point of the reservoir-tubing system. The injection process uses an analysis of the production performance of the well to determine the IPR. Various other methods can be used to draw the IPR curve, but for illustration purpose a straight-line IPR curve has be utilized which is termed the Productivity Index (PI) and has units of BBL/psi. Different PI's can be used to estimate both the transient early life production and later life stabilized production. The production data provide an estimate of the flow possible through the fracture/reservoir system of the well. To model injection, rather that production, this same PI can be utilized but with the higher pressure being in the wellbore and lower pressure in the reservoir. The example shown in FIG. 28 uses an early life with a PI of 10 BBL/psi declining to 5 BBL/psi. Five different lines are shown to represent P_{bh} of 1,500 at the start of the injection cycle, 1,750, 2,000 for early in the injection cycle when the fracture-reservoir system is still being charged and 2,250, and 2,500 psig where there is more interaction with the rock matrix. In this example, the target MMP is 2,500 psig. The “bottomhole” fluid rates combine all of the injected fluids (e.g., water and gas), i.e., the gas volume in reduced to P_{bh} and Tbh. For injection, the 10 BBL/psi injectivity can also be assumed for the fracture-reservoir system and this is utilized in the lower 3 reservoir lines. Later the 5 BBL/psi value it used as the reservoir is more fully re-pressurized. FIG. 28 illustrates Tubing Curves for three different injection cases:
1) QT-800 (co-inj): for the example with 800 psig gas source pressure at the surface. In this example, the injection gas rate was 3 MMscf/day.
2) QT-1300 (co-inj): for the example with 1,300 psig gas source pressure at the surface. In this example, the injection gas rate was 3 MMscf/day.
3) QT-600 (co-inj): for the case with 600 psig gas source pressure at the surface. In this example, the injection gas rate was 2 MMscf/day.

In all of these examples, the liquid rate varied as required to deliver the P_{bh} at various points in the injection cycle. As shown in FIG. 28, total fluid injection rate at bottomhole condition were in the 4,000-6,000 BPD range for the entire injection cycle, while bottomhole pressures increased over the cycle.

The injection process of the present technology can generate a reservoir pressure greater than the Minimum Miscibility Pressure (MMP) of the reservoir oil and the injection gas. This is important for single-well alternating stacked gas/liquid slug application in order for the injected gas to have a significant EOR benefit. For conventional reservoirs, this is also desirable and reservoir pressure can be calculated with the methods as described herein. The processes as described herein can generate a pressure in the created/natural fracture system and the rock surface that is over MMP, while realizing that reaching MMP in the ultra-tight rock may not be practical in terms of time.

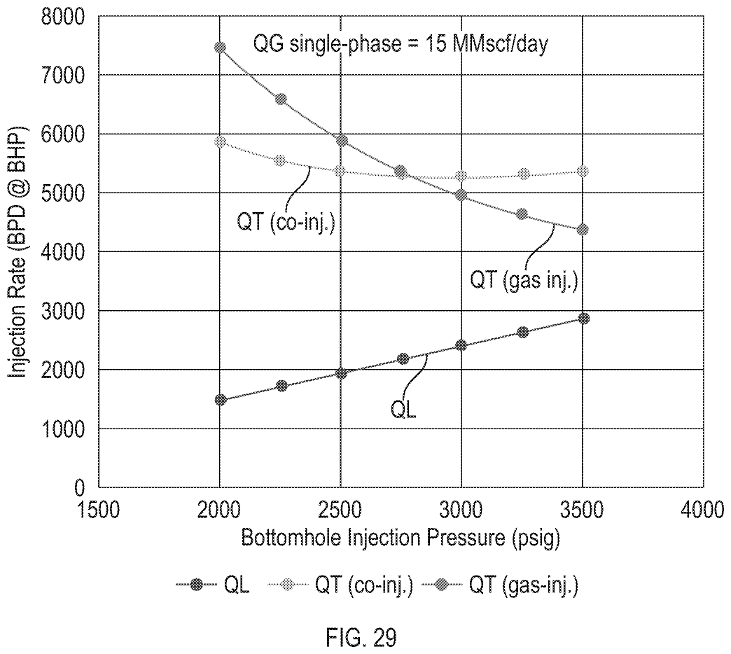

Referring to FIG. 28, the bottomhole injection pressure generated by the injection process is greater than the reservoir pressure. For example, the injection cycle is begun with a reservoir pressure of 1,500 psig. To initiate injection using 800 psig, the required bottomhole pressure is approximately 2,050 psig. To generate this Pbh, a combined gas and liquid rate, a P_{bh} conditions, is approximately 5,700 BPD. As injection continues over the injection cycle, the reservoir pressure increases, and likewise, the P_{bh} required to achieve injection increases. At the end of the injection cycle, when reservoir pressure is about 2,500 psig, P_{bh} is above 3,500 psig. The injection process, as described herein, delivered by the surface module can continually adjust the liquid rates to achieve the required Pbh. As shown in FIG. 29, the average liquid rates start at 1,500 BWPD and moves to nearly 3,000 BWPD at the end of the cycle. In some examples, it is not only necessary to increase the liquid rates, but the gas rate may be decreased. This dynamic process is achieved by analyzing the well primary production rate-time-pressure data, converting this to an injection process, and calculating the tubing curves generated by the injection process. Feedback from the injection rates and pressure can be utilized to confirm the dynamic modeling of the process and make adjustments continually over the injection cycle.

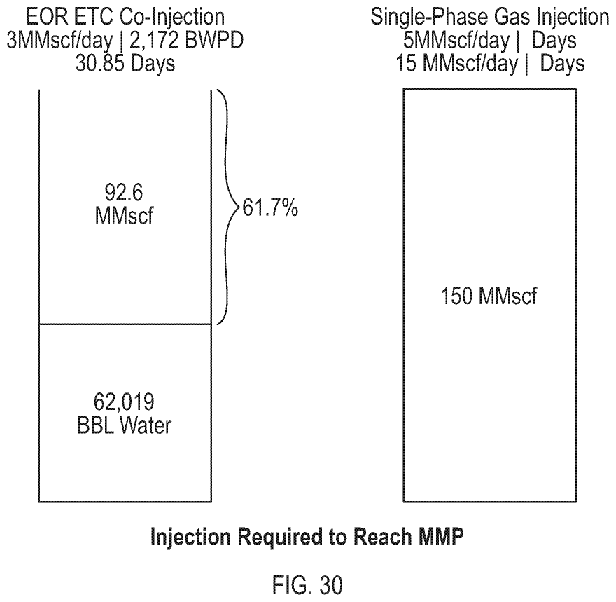

The volumes injected with the injection process can be compared with those injected during a continuous single-phase gas EOR process. Using the single-phase gas injection process as a reference, the same reservoir pressure can be reached by injecting the same reservoir volumes, whether gas or liquid, as long as the gas volumes are converted to reservoir conditions. FIG. 30 illustrates an example where the same reservoir volume has been injected by the injection process and the single-phase gas injection process. As can be seen, the injection process delivered approximately 61.7% of the gas of the single-phase process with the remainder of the reservoir volume occupied by 67,019 BW. FIG. 30 also illustrates the injection rates and anticipated times to reach the same MMP pressure, assuming equivalent leakage. However, leakage out of the drainage area can be expected to be less for the injection process due to the lower mobility of the water-gas mixture.

For conventional water-wet reservoirs, injected water can imbibe into the reservoir rock, thereby producing additional oil through spontaneous imbibition. For oil wet rock, which has been common for unconventional reservoirs in the United States like the Bakken, Eagle Ford and Wolfcamp, surfactant added to the water stream can alter the wettability of the rock, also allowing spontaneous imbibition to occur.

Gas injection in the reservoir is highly mobile and can quickly move out of the drainage area. This is due to the low viscosity of gas and the higher permeability of gas in the fracturing generated by a near-wellbore fracture system, natural fracture system, and conventional reservoir rock. For the injection process, water reduces the mobility of the injected gas, thereby slowing its movement in the reservoir and improving the ability of the gas to stay in the well drainage area. This delivers EOR benefits from miscibility with the oil and a multi-contact miscibility process.

The injected liquid also provides a benefit in terms of time to be repressurized. As water is an incompressible fluid, water can increase reservoir pressure and replace reservoir “voidage” better than compression gas where volume is depended on the pressure and needs to be continually pressurized to fill a given volume.

The injected liquid also provides a cost savings benefit. By utilizing produced water, the injection system utilizes a waste stream that would have incurred a disposal cost. In most cases, when natural gas volumes are replaced by water volumes, the process is more cost effective as natural gas can be sold for beneficial uses and is more expensive than produced water or even a blend of fresh water and produced water.

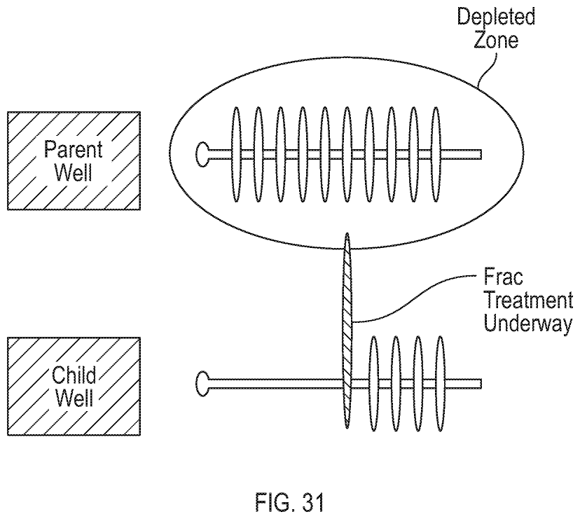

FIG. 31 illustrates an example parent and child well interaction in accordance with aspects of the present disclosure. Interference between older and newer wells is an issue that reduces well performance and recovery in unconventional developments. Hydraulic fracturing processes (frac) are used for stimulating unconventional wells by injecting high pressure water and sand into a wellbore, completion is then carefully setup to create a long vertical fracture. The fractures are created, one-by-one, down the length of the horizontal wellbore from the toe to the heal. The growth and direction of each of these fractures is largely dictated by the stress field in the reservoir. The depleted areas of the reservoir also have a direct influence on the in situ stress field. Often wells are not all drilled at the same time in unconventional developments to allow for early assessment of the reservoir and well completions.

The first-drilled and completed well is referred to as the “Parent Well,” and subsequent drilled and completed wells are referred to as “Child Wells.” Typically, the Parent Well has been produced resulting in a lower-pressure drainage area around the horizontal well/fracture system. FIG. 31 illustrates an example Parent Well with multiple fractures extending from the horizontal wellbore and a shaded low-pressure drainage area created by production of the well. For FIG. 31, the viewpoint is from a downward perspective and the vertical wellbore is represented simply by a circle. When a Child Well is drilled near the Parent Well, the fracturing process can be influenced by the nearby Parent Well.

As shown in FIG. 31, the first four fractures in the Parent Well were successful and stayed in the reservoir area targeted by the Parent Well. However, the sixth Frac (showed darker) followed the path of least resistance and grew into the Parent Well. This creates problems for both wells including a loss of production and recoverable reserves. Furthermore, the Parent Well is now exposed to high-pressure water and sand. This can damage the Parent Well and may even exceed the wellhead pressure, which can create a loss of containment issue at the surface. Large amounts of water entering the Parent Well can effectively “kill” the Parent Well and production may not be able to be restored thereafter.

For the Child Well, the fracture does not effectively cover the intended reservoir drainage area and is skewed to the reservoir around the Parent Well. This results in lower production and recovery. To protect the Parent Well, this well is often shut in and water is pumped into the well to increase pressure in the reservoir that has been depleted by production. This type of “Protect-the-Parent” operation is often effective in allowing successful completion of the Child Well, but the Parent Well may not recover and be damaged. The injection system 600 can be utilized in a Protect-the-Parent process to protect targeted wells.

As an alternative to pumping water into the Parent Well, an injection process 600, as described herein, can be utilized to achieve better results. Pumping high pressure water during the fracturing treatment of the Child Well loads the near-wellbore fracture system, and oil and gas production is often difficult to restore. The injection process 600 injects both gas and liquid by utilizing injection system 600. The expandability of the injected gas is a factor to well unloading when the well is placed back into production, thereby providing energy to remove water from the near-wellbore fracture system and the wellbore.

Injection can include “energized” fluid, which greatly improves the probability of restoring production from the well flowing the fracturing treatments in the Child Well. As described herein, the injection process 600 can be delivered into a Parent Well in a multi-day process to reach a target pressure to prevent interference with the fracturing of the Child Well. Surfactants can also be added to the injected liquid to boost production and improve recovery in the Parent Well, while performing the Protect-the-Parent operation. Alternatively, the pressure in the depleted Parent Well can be brought above the MMP, and Miscible EOR recover can be delivered to the Parent Well during the Protect-the-Parent operation.

Use of the injection process 600 also provides operations at a low cost while also lowering risk of conducting an EOR pilot in a particular field, area of a field, or zone.

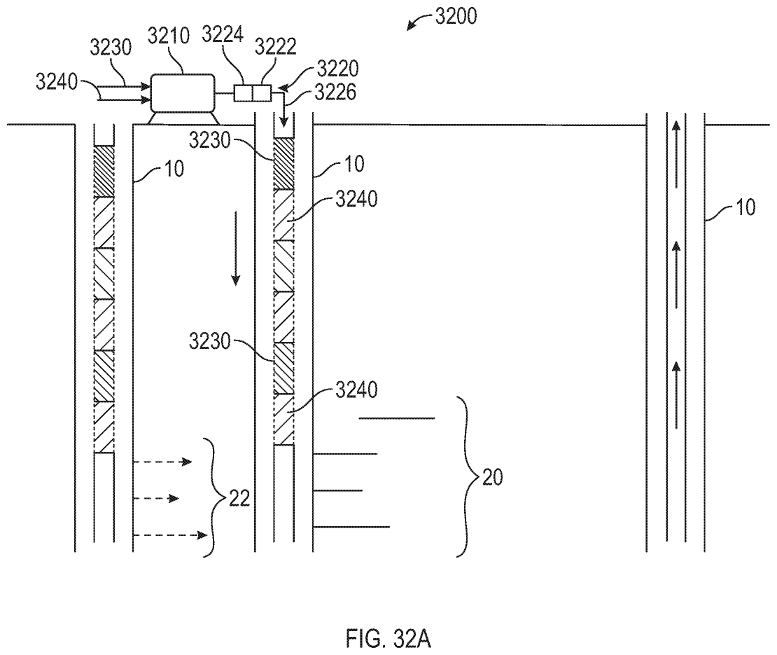

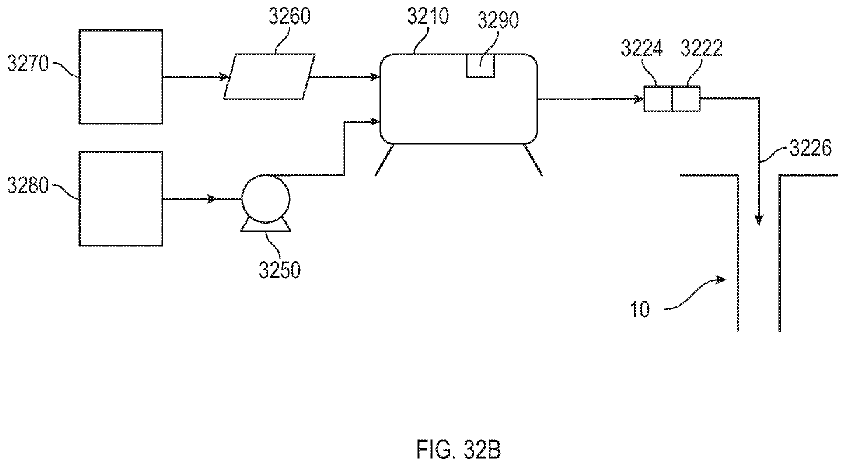

This disclosure provides additional aspects, examples, and configurations of the RSSS co-injection process and system. These aspects can be implemented individually or in combination, and can be incorporated into or used with the systems, methods, and/or operations, described herein with reference to FIGS. 4-31 described above, and FIGS. 32A-B described below. An illustration of at least one aspect of a co-injection configuration is illustrated in FIGS. 32A-B, which shows alternating liquid and gas segments delivered to a wellbore.

FIG. 32A shows an aspect in which the EOR system 3200 includes buffer tank 3210, fluid dispensing system 3220, liquid valve 3222, gas valve 3224, and discharge line 3226 connected to a wellbore 10. Buffer tank 3210 is connected to gas supply 3270 and liquid supply 3280 (illustrated in FIG. 32B) and is configured to hold these fluids at a common internal pressure for delivery toward fluid dispensing system 3220. Fluid dispensing system 3220 includes liquid valve 3222 and gas valve 3224, each configured to regulate the introduction of liquid and gas phases into discharge line 3226.

In at least one aspect, discharge line 3226 delivers alternating liquid segments 3230 and gas segments 3240 into wellbore 10. Liquid segments 3230 can optionally carry diverter material or include entrained gas bubbles. Gas segments 3240 can be interposed between successive liquid segments 3230. The alternating liquid and gas segments 3230, 3240 move downward within wellbore 10, and fractures 20 extending from the wellbore 10 can receive one or both phases during operation.

FIG. 32B shows an aspect in which the EOR system 3200 includes a buffer tank 3210, a fluid dispensing system 3220, a liquid valve 3222, a gas valve 3224, a discharge line 3226, a pump 3250, a compressor 3260, a gas supply 3270, liquid supply 3280, and/or a level sensor 3290. Gas supply 3270 and liquid supply 3280 are connected to buffer tank 3210. Pump 3250 is connected to buffer tank 3210 and is configured to introduce liquid into the tank during co-injection operation. Compressor 3260 is arranged along gas supply 3270 and is configured to increase the pressure of incoming gas when higher-pressure operation is desired.

Fluid dispensing system 3220 is connected downstream of buffer tank 3210 and includes liquid valve 3222 and gas valve 3224, each configured to meter and control the respective phases delivered into discharge line 3226. Level sensor 3290 is positioned to monitor fluid level or phase distribution within buffer tank 3210. Discharge line 3226 is connected downstream of fluid dispensing system 3220 and directs the combined phases toward wellbore 10.

In FIGS. 32A and 32B, the buffer tank 3210 may operate similarly to the buffer tanks detailed throughout the specification, such as buffer tank 618 described in connection with FIGS. 5 and 6, wherein it maintains a common internal pressure for both gas and liquid phases and supports stable delivery of the alternating liquid and gas segments 3230, 3240. Similarly, the gas supply 3270 operate similar to the gas supply 602 and gas compressor systems discussed in FIGS. 4 through 6, providing compressed gas at controlled pressures to the buffer tank and injection system. The liquid supply 3280 operates similar the liquid source 604 as described in FIGS. 4 and 6, which may include water, produced water, or chemically treated fluid streams combined with injection chemicals as described in the mixing tanks 630. Both gas supply 3270 and liquid supply 3280 feed the buffer tank 3210, which cooperatively supplies pressurized fluids through fluid-dispensing components such as gas valve 3226 and liquid valve 3228, which may operate similar to valves 680 and/or 676, respectively, in FIG. 6. The coordinated actuation of these valves regulates the injection sequence of alternating gas and liquid slugs into the combined injection flow path leading to the wellbore 10, consistent with the slug flow generation process detailed elsewhere.

Although FIGS. 32A and 32B illustrate a vertical wellbore, the EOR system 3200 may operate in horizontal portions of a wellbore in the same manner. In aspects, the orientation of the wellbore (e.g., vertical or horizontal) does not limit the effectiveness of the EOR system 3200.

In aspects, buffer tank 3210 may include level sensor 3290 configured to determine fluid level or phase distribution within the tank. The level sensor 3290 is operable to determine a spectrum of densities from a top of the buffer tank 3210 to a bottom of the buffer tank 3210. The baseline level detection of the level of fluid and/or gas in the buffer tank 3290 may rely on differential-pressure measurement, when a distinct gas-liquid interface is present. Advantageously, a gamma-ray densitometer array may be positioned in or along buffer tank 3210 to provide density measurements from the top to the bottom of the tank and is configured to determine liquid level even under difficult conditions where the gas-liquid interface is ill defined or not defined. The gas-liquid interface is ill defined or not defined when there is no clear boundary or layer separating the gas and liquids in the tank. These conditions include foaming and the presence of liquid hydrocarbons above water-based contents. Advantageously, this enables identification of stratified or mixed phases and supports accurate level determination under conditions where differential-pressure sensing is less reliable. This may be particularly beneficial when CO₂ is injected, as dense-phase CO₂ or condensed hydrocarbons may form distinct layers that otherwise makes level detection difficult or inaccurate. In aspects, the level sensor is arranged in or around the buffer tank 3210 to detect a gas-liquid interface in the presence of foams, emulsions, condensate layers, and/or liquid hydrocarbons and to determine a vertical density profile of the fluids in the buffer tank 3210. The improved level measurement supports management of fluid inventory within buffer tank 3210, facilitates operation of pump 3250 and fluid dispensing system 3220, and improves overall control of alternating liquid and gas segments 3230, 3240.

In some aspects, system 3200 may be configured using surface equipment rated according to various ANSI pressure classes, including ANSI 600-class, ANSI 900-class, and ANSI 1500-class components. Gas supplied from gas supply 3270 may be conditioned by compressor 3260 to reach pressures appropriate for the selected equipment class before entering buffer tank 3210. Advantageously, ANSI 600-class configurations may operate at lower surface pressures suitable for many co-injection applications, while ANSI 900-class configurations may support operation at approximately 2,200 psi, and ANSI 1500-class configurations may support operation at approximately 3,500 psi. These higher-pressure configurations may allow increased volumes of gas to be incorporated into gas segments 3240, support formation of higher downhole pressures in wellbore 10, and/or improve miscibility of the injected gas segments 3240. Liquid from liquid supply 3280 delivered by pump 3250 may continue to form liquid segments 3230. Fluid dispensing system 3220 meters both liquid and gas at the selected elevated pressure. These aspects may provide improved EOR performance where enhanced pressure capability or increased gas-delivery capacity is beneficial.

In some aspects, fluid dispensing system 3220 can operate in a bubble-flow configuration. The bubble-flow configuration injects liquid slugs and gas bubbles by alternately opening and closing the liquid and gas valves 3222, 3224. In aspects, the gas valve 3224 remains open for some period of time the liquid valve 3222 is open, such that gas bubbles are entrained in the liquid flowing from the liquid valve. For example, gas valve 3224 remains open while liquid valve 3222 cycles from open and close to form liquid segments 3230 containing entrained gas bubbles. Gas supply 3270 and compressor 3260 provide gas to buffer tank 3210 at the selected operating pressure, and pump 3250 adds liquid from liquid supply 3280. Liquid segments 3230 enter discharge line 3226 alongside approximately continuously, or longer interval, delivered gas so that liquid segments 3230 include entrained gas bubbles 3236. Gas segments 3240 may still form between liquid segments 3230, depending on the timing of liquid valve 3222. For example, when liquid valve 3222 is closed, gas segments 3240 are formed while gas valve 3224 remains open. In aspects, the gas valve 3224 may be closed during production of some of the liquid segments 3230 to produce some liquid segments 3230 with no entrained gas bubbles

In some aspects, the compressor 3260 may be fluidly coupled with the gas-supply path between gas supply 3270 and buffer tank 3210 to increase the pressure of the incoming gas prior to co-injection. In such aspects, compressor 3260 is a booster compressor. The compressor 3260 may elevate gas pressure to the level required for the selected operating mode, such as those associated with ANSI 600-class, ANSI 900-class, or ANSI 1500-class components. In advantageous aspects, integrating compressor 3260 into the gas-supply path allows system 3200 to meet a wider range of operating-pressure requirements and provides operational flexibility where available gas pressure from gas supply 3270 varies over time or across locations. In at least one aspect, the gas supply pressure on site will be limited to about 1,300 psi, although up to 2,000 psi gas supply pressure may be available at certain locations. The compressor 3260 is thus configured to boost the gas supply pressure beyond generally available gas supply pressures, including approximately 2,000 psi, greater than 2,000 psi, and including up to or greater than 3,500 psi.

In some aspects, buffer tank 3210 may receive and manage a plurality of liquid or gas fluids supplied from liquid supply 3280 and gas supply 3270 to support expanded injection schemes. These fluids may include produced water, natural gas, Y-grade hydrocarbon streams, gaseous CO₂, and dense-phase CO₂, individually or in combination. Advantageously, this aspect enables system 3200 to support a broad range of EOR and subsurface-injection applications by accommodating varying fluid types, viscosities, densities, and phase behaviors while maintaining the alternating-segment architecture used for co-injection. Pump 3250 may introduce selected liquid(s) into buffer tank 3210, while compressor 3260 may condition selected gas(es) for entry into the buffer tank 3210. Fluid dispensing system 3220 may then meter liquid segments 3230 and gas segments 3240 into discharge line 3226 for delivery to wellbore 10. In some aspects, the ratio of gas to liquid depends on the selected liquid and/or gas fluids. In some aspects, two or more liquids and/or two or more gases may be used during one deployment of an EOR system 3200. The selected fluids may be chosen based on soil compositions of the wellbore, depth of the wellbore, pressure of the wellbore, and/or other well or surface conditions to optimize efficiency and performance of EOR system 3200.

In some aspects, system 3200 may be arranged on a mobile platform to facilitate transportation, rapid deployment, and repositioning among multiple well sites. The mobile platform may be, by way of example, a flat bed or other trailer, or a shipping container. Components such as buffer tank 3210, pump 3250, compressor 3260, fluid dispensing system 3220, liquid supply 3280, and gas supply 3270 may be mounted together within an ISO-dimensioned container, including a 20-ft shipping container, or may be mounted on a 20-ft flatbed trailer. This configuration allows the entire system to be transported as a single integrated unit, enabling quick installation and setup at different locations and providing operational flexibility where on-site infrastructure or spacing does not support permanent equipment placement.

A method for bubble-flow injection can include, at operation 1, opening gas valve 3224 to establish continuous gas flow from gas supply 3270 and compressor 3260 into buffer tank 3210 and through discharge line 3226. At operation 2, liquid valve 3222 is opened to introduce liquid from liquid supply 3280 and pump 3250 into discharge line 3226. At operation 3, liquid valve 3222 is closed to allow gas to continue flowing while the liquid entering discharge line 3226 forms a liquid segment 3230 containing entrained gas bubbles 3236. At operation 4, operations 2 and 3 are repeated to generate successive bubble-containing liquid segments interspersed with gas segments 3240, producing a bubble-flow pattern directed toward wellbore 10.

In aspects, the bubble-flow configuration advantageously reduces the mechanical cycling required of gas valve 3224 and/or may advantageously provide smoother pressure transitions in discharge line 3226. Entrained gas bubbles 3236 may support pressure control and flow stability in wellbore 10. As shown in FIG. 32A, bubble-containing liquid segments 3230 move through discharge line 3226 into wellbore 10 and can mix or separate depending on conditions within the well. In aspects, the bubble-flow configuration advantageously offers operational flexibility when system 3200 is used in environments where reduction of valve cycling, smoother pressure patterns, or increased gas throughput into wellbore 10 may be desired. As an added benefit, the bubble flow injection also puts less stress on the wellbore and/or EOR system, since there is a better pressure balance with less inertia and water hammer effects. The fluid dispensing system 3220 meters the liquid via liquid valve 3222, while maintaining gas flow to create liquid segments with entrained gas bubbles that function as distributed compressible cushions; the entrained gas in each liquid segment 3230 increases the effective bulk compressibility of the liquid segment 3230 and slows pressure waves, which softens spikes and reflections and reduces water hammer flow changes as flow rates of the liquid and gas segments 3230, 3240 change throughout the wellbore. Moreover, wear on the gas valve 3224 is reduced since it remains open, or remains open for longer intervals.

In additional advantages of this disclosure, entraining gas bubbles in a liquid segment in the bubble-flow configuration enables for efficient use of the RSSS injection processes described herein in smaller diameter production tubing. Smaller diameter tubing refers to production tubing used within the wellbore having an internal diameter of approximately 2⅜ inches to 4½ inches, employed in the injection flow path. In aspects, smaller diameter tubing includes tubing having an internal diameter ranging from about 1 inches to about 6 inches. The fluid dispensing system 3220 and injection methods disclosed herein accommodate smaller diameter tubing sizes by generating bubble-containing liquid segments and gas segments with flow characteristics and pressure control optimized to maintain flow stability within these restricted diameters by reducing the frictional pressure losses due a decrease in separate phase flow rates of the liquid and gas segments 3230, 3240.

In some aspects of EOR system 3200, buffer tank 3210 can be operated in a mode in which gas contained within the buffer tank 3210 is directed to a lower-pressure system during the liquid filling phase of a slug flow generation process. For example, while liquid is introduced into the buffer tank 3210 from liquid supply 3280 through pump 3250, gas in buffer tank 3210 may be vented to a lower-pressure system. The lower-pressure system may be the well, or pad production vessel or separator, a lower-pressure gas line, a flare system, and/or the atmosphere.

Buffer tank 3210 is supplied with liquid and gas through liquid supply 3280 and gas supply 3270, respectively, and maintains both phases at a common internal pressure for use by fluid dispensing system 3220. During operation, liquid added by pump 3250 increases the tank's internal liquid volume while gas retained in the headspace of buffer tank 3210 regulates the overall tank pressure. In this aspect, gas valve 3224 and liquid valve 3222 can be positioned to isolate the tank from discharge line 3226, and an auxiliary vent line may be opened to allow gas to exit buffer tank 3210 to the lower-pressure system. This reduces the internal buffer tank pressure prior to or during liquid replenishment. Lowering the buffer tank pressure in this manner can reduce the discharge pressure against which pump 3250 operates, enabling the pump 3250 to deliver liquid into the buffer tank 3210 more efficiently or under different surface pressure conditions supplied by gas supply 3270.

When buffer tank 3210 has been replenished with liquid, the auxiliary vent connection can be closed and the buffer tank 3210 returned to the operating pressure used for co-injection. Gas supply 3270, with or without compressor 3260, can re-pressurize buffer tank 3210 to the pressure level selected for subsequent co-injection cycles. This configuration allows liquid to be introduced while limiting the load on pump 3250, and supports operation under a wider range of surface supply pressures. Fluid dispensing system 3220 thereafter meters liquid and gas through liquid valve 3222 and gas valve 3224 to generate liquid segments 3230 and gas segments 3240 as shown in FIG. 32A. By reducing the required pump pressure during tank filling, this aspect can support efficient operation since less power is needed and/or a smaller pump may be used. Discharge line 3226 carries the resulting liquid and gas segments to wellbore 10 once the tank is returned to the pressure selected for co-injection.

For example, if EOR system 3200 uses a 1,200-psig gas source and a 200-psig pipeline or separator is available, buffer tank 3210 may be connected to the 200-psig system so that, during the liquid-fill portion of the cycle, gas in buffer tank 3210 is vented to the 200-psig system. This allows filling at approximately 200 psig instead of 1,200 psig. In aspects, this advantageously reduces power usage by a factor of about six. This also enables use of smaller pumps or pumps with lower horsepower ratings. Further, this reduced refill pressure of the buffer tank 3210 can allow different pumping technologies that may be more cost effective, such as rotodynamic pumps, to be used instead of positive-displacement pumps.

In some aspects, diversion of the liquid segments 3230 and/or gas segments 3240 may implemented to redirect flow from higher-capacity fracture paths (e.g., fractures 20) to lower-capacity fracture paths 22 to enable more of the reservoir to be contacted by the RSSS EOR system. In aspects, diversion of co-injected water and gas may be carried out by delivering diverting material within selected liquid segments 3230 formed by fluid dispensing system 3220. Liquid segments 3230 carrying the diverting material travel through discharge line 3226 into wellbore 10 and enter fractures 20 where the material can accumulate at perforations or constrictions of higher-conductivity fractures. This at least partially restricts those flow paths so that subsequent liquid and gas phases may enter lower-capacity or previously under-swept fractures 22. Diverter materials may include chemicals, particulates, emulsifiers, or physical objects such as balls, knots, flakes, starches, or rope-type diverters. Diverters may be permanent or dissolvable after a selected time and/or at a predetermined temperature. Surfactants may be included to enhance performance of the diverter-liquid mix segments.

Diverter materials may be introduced by mixing into the liquid stream entering buffer tank 3210 from liquid supply 3280, or by using a mechanical addition device positioned upstream of liquid valve 3222. Liquid valve 3222 may selectively enable diverter liquid mix to flow into discharge line 3226 in segments. In aspects, gas valve 3224 selectively permits gas to form gas segments 3240 between the diverter liquid mix segments. Viscosity-increasing agents may also be introduced along with diverting material to modify liquid behavior during the diversion interval. Viscosity-increasing agents may include: gums such as xanthan or guar, cellulose-derived thickeners, synthetic water-soluble polymers, and/or gel systems. In aspects, the length of time the diverter material is mixed with the liquid segments 3230 and injected into the wellbore may be predetermined such that the diverter material is inhibited from diverting into, or too far into, higher capacity fractures 20.

In aspects, this advantageously enables selective flow diversion without downhole intervention and supports precise placement of diverter material into targeted fracture regions. In further advantageous aspects, these configurations support improved near-wellbore placement of diverter while limiting premature gas leak-off.

A method for injecting diverter material towards lower capacity fractures may include one or more operations including: supplying diverter liquid from liquid supply 3280 to buffer tank 3210; maintaining gas pressure using gas supply 3270 and compressor 3260; selectively causing series of diverter-carrying liquid segments 3230 through liquid valve 3222 to flow to the wellbore over a predetermined period of time; forming gas segments 3240 between one or more diverter carrying-liquid segments 3230 by operating gas valve 3224; and/or returning to diverter-free operation after the predetermined period of time. Level sensor 3290 may be used to monitor buffer tank 3210 volume to maintain predetermined liquid-to-diverter material proportions. Advantageously, this aspect enables controlled fracture diversion across multiple cycles, adjustable diverter concentration, and re-treatment using dissolvable or temperature-responsive diverters when redistribution of flow is desired. Once the diverter material is in place, further liquid slugs are diverted due to the diverter material to other fractures to reach more of the wellbore and/or lateral sections of the well.

In some aspects, EOR system 3200 may mitigate gas leak-off by forming alternating-phase structures that include liquid segments 3230 and gas segments 3240 generated by fluid dispensing system 3220. Gas breakthrough to adjacent wells may be observed in prior high-pressure gas-only-injection processes, particularly where gas is injected continuously and at elevated pressure. In contrast, during operation of system 3200, co-injected liquid delivered from liquid supply 3280 through pump 3250 into buffer tank 3210 reduces the mobility of the gas supplied from gas supply 3270 and compressor 3260. Liquid valve 3222 and gas valve 3224 generate liquid segments 3230 and gas segments 3240 through discharge line 3226 so that both phases enter wellbore 10 in alternating form. This co-injected liquid reduces gas mobility and can greatly reduce breakthrough of injected gas into adjacent wells, supporting improved EOR performance during injection cycles, including Huff-and-Puff applications where retention of injected gas near wellbore 10 is beneficial.

In some aspects, the alternating-phase configuration offers advantages as compared to Water-Alternating-Gas (WAG) processes, which rely on longer water-injection intervals followed by longer gas-injection intervals. WAG processes use high-pressure compressors to inject gas at pressures sufficient to overcome reservoir pressure, and the extended gas-injection periods can allow gas to migrate into adjacent wells. This can result in limitations on gas-injection duration and reduce the multi-contact miscibility benefit achievable in Huff-and-Puff operations. In contrast, the RSSS co-injection process provides mobility control on a small scale, with multiple gas bubbles and liquid slugs present in the wellbore at the same time. The interspersed liquid segments 3230 reduce mobility of each gas bubble formed at the surface, preventing rapid migration through fractures or matrix pathways toward adjacent wells. Rather than forming separate large-scale fronts of gas and water as in a WAG process, system 3200 mitigates mobility of individual gas segments 3240 so that they move in coordination with surrounding liquid segments 3230. This provides a distinct mobility-control mechanism in which gas movement is moderated by the adjacent presence of liquid, supporting reduced leak-off and improved retention of injected gas near wellbore 10.

In some aspects, EOR system 3200 may be used to provide pressure support to a producing well during offset hydraulic-fracturing operations, sometimes referred to as “frac hits,” in which fracturing fluid from a nearby well can enter the drainage region of the producing well. During such offset fracturing operations, the lower-pressure region surrounding the producing well may receive frac fluid, water, or sand, which can interrupt or diminish production. The alternating liquid segments 3230 that are delivered through discharge line 3226 into wellbore 10 contribute hydrostatic pressure and help maintain liquid contact near wellbore 10. The alternating gas segments 3240 provide compressible support that can help dampen or moderate pressure waves transmitted from an adjacent fracturing treatment. In this aspect, co-injection of liquid and gas may increase the near-wellbore pressure surrounding wellbore 10 so that offset fracturing fluids are less likely to enter the well's fracture network. Thus, the EOR system 3200 can re-pressurize the producing well and may advantageously result in high bottomhole pressure.

In additional aspects, gas segments 3240 supplied with the alternating sequence may later support unloading of liquids from wellbore 10. The compressibility of gas segments 3240 can provide energy via expansion of the pressurized gas during flowback to help lift fluids and restore production. Liquid segments 3230 reduce gas mobility and maintain closer proximity of injected gas to wellbore 10, assisting with pressure maintenance during the fracturing operation. This combination of compressible gas segments 3240 and incompressible liquid segments 3240 phases provides coordinated pressure support during the offset treatment. In at least one aspect, this disclosure advantageously allows the existing well to remain on production or return to production more quickly following an offset fracturing event, supports mitigation of fracture-hit effects without requiring downhole mechanical intervention, and reduces the likelihood of formation-fluid inflow into wellbore 10 by maintaining a controlled pressure environment during the fracturing of an adjacent well.

In some aspects, EOR system 3200 provides a further advantage in that it may operate even during short-term low-pressure gas injection into a wellbore 10 during processing-facility upsets or pipeline offtake restrictions. During such events, gas that would normally be flared or cause wells to be shut in may instead be injected at low pressure into one or more depleted wells that are suitable for temporary injection. These depleted wells may be in the producing formation, an adjacent formation, or any formation that is sufficiently depleted to accept injection. In these aspects, buffer tank 3210 receives liquid from liquid supply 3280 via pump 3250 and gas from gas supply 3270, which may include separator gas or gas-lift gas available at the well pad, battery, or central facility. Compressor 3260 may be used when available to increase pressure of the gas supply 3270 but is not required for low-pressure operation. Upon detection of a facility upset, system 3200 may be operated in a mode that rapidly transitions to the low-pressure co-injection of gas and liquid segments 3230 and 3240.

Low-pressure gas injection under this aspect is achieved by using the alternating liquid segments 3230 and gas segments 3240 to generate high bottomhole pressure in wellbore 10 even when the available gas supply 3270 is at relatively low pressure. The co-injected liquid, via liquid segments 3230, provides the hydrostatic pressure component needed to reach injection pressure in the reservoir, while gas segments 3240 provide the compressible phase energy that contributes to injection performance despite low surface-gas pressure. Liquid used to form liquid segments 3230 may include produced water available on the pad, battery, or central facility. In aspects, this advantageously allows system 3200 to maintain injection for days or weeks longer than single-phase gas injection alone would be able to under the same constrained-pressure conditions. This enables continued EOR activity and may allow multiple wells connected to the same facility to continue producing throughout the upset or offtake episode, preserving production and avoiding the shutdown conditions that would otherwise occur when high-pressure gas supply is temporarily unavailable.

In further advantageous aspects, the RSSS co-injection may provide improved containment of injected gas near wellbore 10 due to the higher viscosity of the liquid segments 3230 being constantly and alternately injected together with the gas segments 3240. The higher viscosity liquid segments 3230 inhibit movement of the gas segments 3240 to adjacent wells. This beneficially supports retention of gas around the intended injection well and/or improves the efficiency of gas usage during EOR, compared to gas only injections or long interval liquid injections.

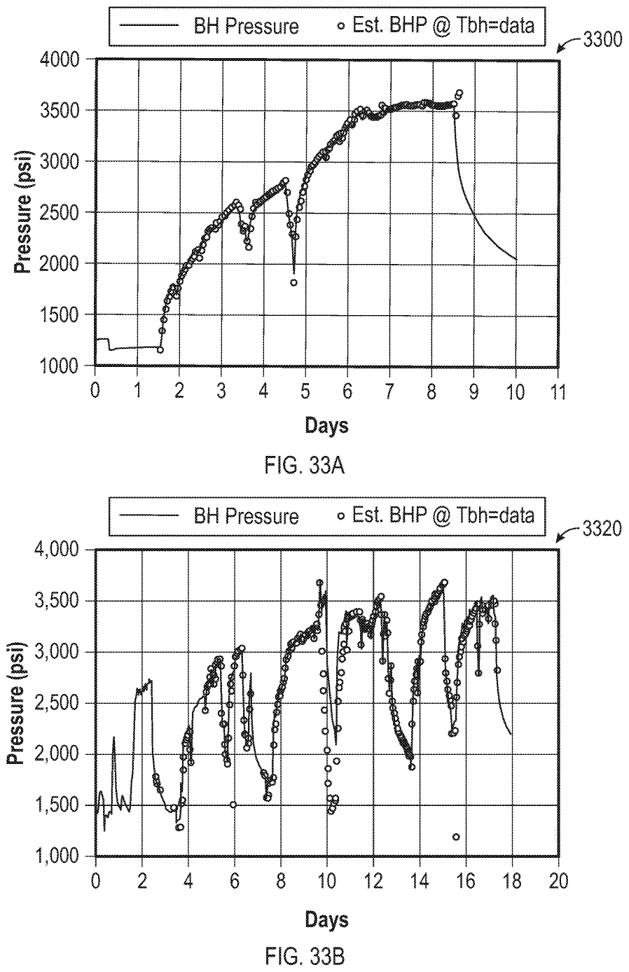

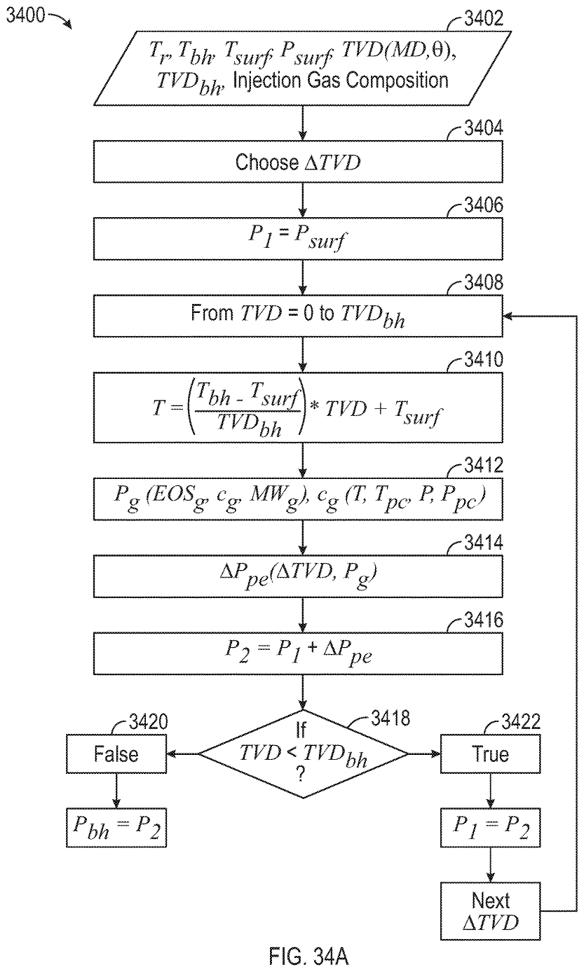

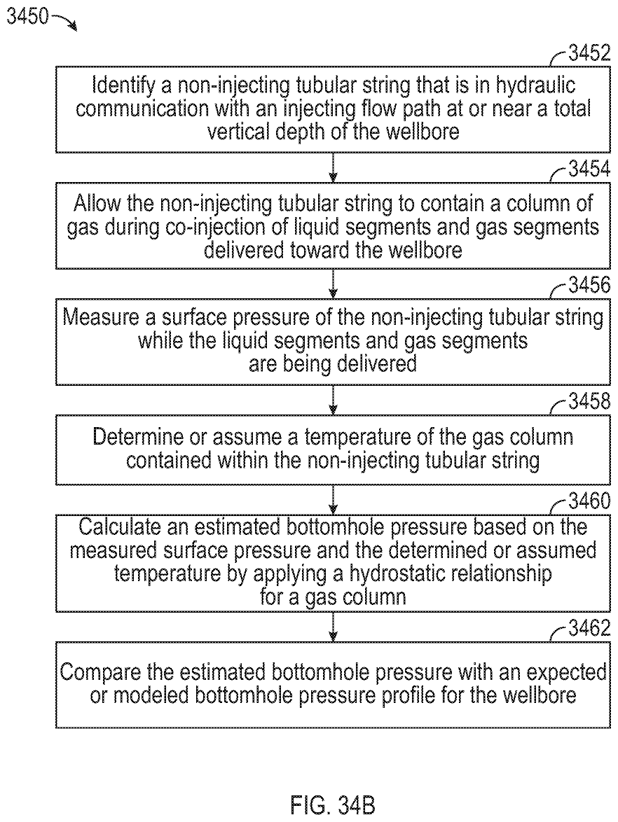

With additional reference to FIGS. 33A-B and 34A-B, system 3200 enables estimation of bottomhole pressure in a wellbore 10 the hydrostatic pressure of a column of gas in a “dead string” during RSSS injection. In FIGS. 33A and 33B, “BH Pressure” refers to bottomhole pressure measured by a downhole pressure gauge. “Est. BHP” refers to bottomhole pressure estimated using the dead-string hydrostatic method, including use of downhole temperature data when available (e.g., Tbh=data). FIG. 33A and FIG. 33B depict measured and estimated bottomhole pressure for separate injection intervals (e.g., separate injections and/or separate wells). FIGS. 34A-B illustrate methods for estimating the bottomhole pressure in a wellbore 10. FIGS. 33A-B illustrate bottomhole pressured using the method for estimating the bottomhole pressure compared to measured bottomhole pressure. When hydraulic communication exists between the injecting flow path and the non-injecting flow path at or near total vertical depth, surface pressure measured at the dead string may be used to estimate bottomhole pressure by applying hydrostatic relationships for a gas column. Surface temperature for the gas column may be used when available, or assumed when not measured. In advantageous aspects, this enables determination of bottomhole pressure without requiring installation of permanent or temporary downhole gauges, reducing operational cost and simplifying pressure monitoring.

FIG. 33A shows a graph 3300 illustrating an example of measured bottom hole pressure with estimated bottomhole pressure in a well derived from a method of estimating bottomhole pressure and FIG. 33B shows a graph 3320 illustrating another example of measured bottomhole pressure with estimated bottomhole pressure in another well using the methods for estimating bottomhole pressure described herein. FIGS. 33A and 33B, demonstrate that the estimated bottomhole pressure can track the measured pressure behavior during an injection interval, supporting the use of the dead-string method as a practical, surface-based technique for monitoring downhole pressure trends and managing injection conditions in wellbore 10.

Bottomhole pressure “P_{bh}” may be estimated using the hydrostatic pressure of a column of injected gas in the “dead string” during RSSS injection. The dead string is assumed to be filled with injection gas during RSSS injection because it is the less dense phase. As illustrated in FIG. 34A, a method 3400 estimates bottom hole pressure “P_{bh}” using the surface pressure “P_{surf}” and the surface temperature “T_{surf}” measurement of either the annulus or tubing, and/or whichever is not the injection path, if there is fluid communication to the injection path at or around the bottom hole total vertical depth “TVD_{bh}”. The fluid communication between the injection path and dead string allows the for P_{bh} created during RSSS injection to be estimated as it is applied to the bottom of the column of injected gas at TVD_{bh}. At operation 3402, the P_{surf}, T_{surf}, and TVD_{bh} are determined.

In aspects, operation 3402 includes receiving or determining a wellbore schematic that includes a beginning and ending measured depths “MD” of casings, production tubing, producing interval piping, valves, packers, and/or bottom hole configuration. A communication point, if any, may be determined using any of the aforementioned characteristics of the wellbore. In aspects, a gas composition for the calculations of molecular weight MW_{g}, a gas density ρ_{g}, pseudo critical temperature T_{pc}, pseudo critical pressure P_{pc}, equation of state parameters EOS_{g}, and gas compressibility c_{g} may each be determined when using a gas as an injection fluid. In aspects, a normal reservoir temperature Tᵣ may be measured, provided, or estimated.

In aspects, a drilling survey may be determined or received, wherein the drilling survey represents the well trajectory as a series of measured-depth (MD) segments, each segment having a corresponding deviation angle θ (e.g., inclination and/or azimuth), for at least a portion of, or the entirety of, the well. In some aspects, the measured bottom hole depth of the communication point MD_{bh} may be determined or received. Then, the TVD_{bh} can be calculated as a function of changes in MD and θ. Any of the above values may be measured using RSSS injection equipment and sensors, including in place sensors, LIDAR, or sensors sent downhole via a wellbore tool.

Method 3400 for determining P_{bh} includes measuring surface temperature and surface pressure at operation 3402. An increment of total vertical depth “ΔTVD” is chosen for successively determining pressure at each increment ΔTVD. P_{surf} is set as the first pressure P₁. A next pressure “P₂” is calculated by accounting for the changes in pressure due to potential energy “ΔPₚₑ” in a chosen increment of total vertical depth “ΔTVD”:

$${P}_{2} = {P}_{1} + Δ {P}_{p e}$$

wherein P₁=P_{surf}. In aspects, P₁ is the pressure at the top of a first depth increment, and P₂ is the pressure at the bottom of the first depth increment. Thus, the TVD starts at 0, and P2 is calculated at the first ΔTVD.

For the injected gas:

$$Δ {P}_{p e} ( Δ T V D , {ρ}_{g} )$$

wherein ΔPₚₑ is the incremental hydrostatic pressure change, and is a function of ΔTVD and the density ρ_{g} of the injected gas and/or density of the fluid ρ_{f} in the increment ΔTVD. The density of the gas may be expressed as:

$${ρ}_{g} ( {EOS}_{g} , {c}_{g} , M {W}_{g} )$$

wherein EOS_{g} represents the selected gas equation of state, c_{g} is the gas compressibility, and MW_{g} is the molecular weight of the injected gas. The gas compressibility may be expressed as

$${c}_{g} ( T , {T}_{pc} , P , {P}_{p c} )$$

wherein Tis the local temperature in the increment ΔTVD, P is the local gas pressure, T_{pc} is the pseudo-critical temperature of the gas, and P_{pc} is the pseudo-critical pressure of the gas.

The temperature “T” from the surface temperature throughout an assumed bottom hole temperature “T_{bh}” can be found using a linear approximation:

$$T = ( \frac{{T}_{b h} - {T}_{surf}}{{TVD}_{b h}} ) * TVD + {T}_{surf}$$

Where the assumed bottom hole temperature is usually between the surface injection temperature and reservoir temperature:

$${T}_{surf} < {T}_{b h} < {T}_{r}$$

And TVD_{bh} can be calculated by the summation of total vertical depth “TVD” as a function of MD and corresponding θ:

$${TVD}_{b h} = {\sum }_{M D = 0}^{M {D}_{b h}} TVD ( MD , θ )$$

The bottomhole pressure calculation thus traverses down the wellbore in increments of ΔTVD until TVD_{bh} is reached.

Thus, method 3400 includes determining at operation 3402 one or more of Tᵣ, T_{bh}, T_{surf}, P_{surf}, TVD (MD, θ), TVD_{bh}, and/or Injection Gas Composition. At operation 3404, a increment of TVD is selected, and at operation 3406, P₁ is set to P_{surf}. Then operation 3408, TVD is set to 0, and operations 3408 through 3418 are repeated until TVD_{bh} is reached, as shown by the decision tree at operation 3418.

At operation 3410, temperature “T” from the surface temperature throughout an assumed bottom hole temperature “T_{bh}” is approximated using the above equation. Operation 3412 determines the density of the gas and the compressibility of the gas. At operation 3414, the incremental hydrostatic pressure change ΔPₚₑ is determined, which is then added to P₁ at operation 3416 to determine P₂. At operation 3418, the current TVD is compared to TVD_{bh}. If the TVD is more than TVD_{bh}, then method ends at operation 3420, and the bottomhole pressure P_{bh} is equal to P₂. If TVD is less than TVD_{bh}, then the method 3400 continues with operation 3420, and the first pressure P₁ is set to P₂, and then operations 3408-3418 are repeated for the next ΔTVD.

With reference to FIG. 34B, a method 3450 for estimating bottomhole pressure using a dead string may include, at operation 3452, identifying a non-injecting tubular string that remains in hydraulic communication with an injecting flow path at or near the total vertical depth of wellbore 10. At operation 3454, allowing the non-injecting tubular string to contain a column of gas during operation of system 3200 while alternating liquid segments 3230 and gas segments 3240 are delivered to wellbore 10. At operation 3456, measuring the surface pressure of the non-injecting tubular string during co-injection. At operation 3458, determining or assuming a temperature for the gas column present within the non-injecting tubular string. At operation 3460, calculating an estimated bottomhole pressure by applying hydrostatic relationships for a gas column using the measured surface pressure and the temperature determined or assumed in operation 3470. At operation 3462, comparing the estimated bottomhole pressure to an expected or modeled bottomhole pressure profile to evaluate injection behavior during the co-injection interval. In some aspects, method 3450 may further include storing or displaying the estimated bottomhole pressure, or adjusting injection parameters in response to the estimated bottomhole pressure values. In some aspects, based on a measured bottomhole pressure exceeding or falling below a predetermined threshold, an alarm may sound.

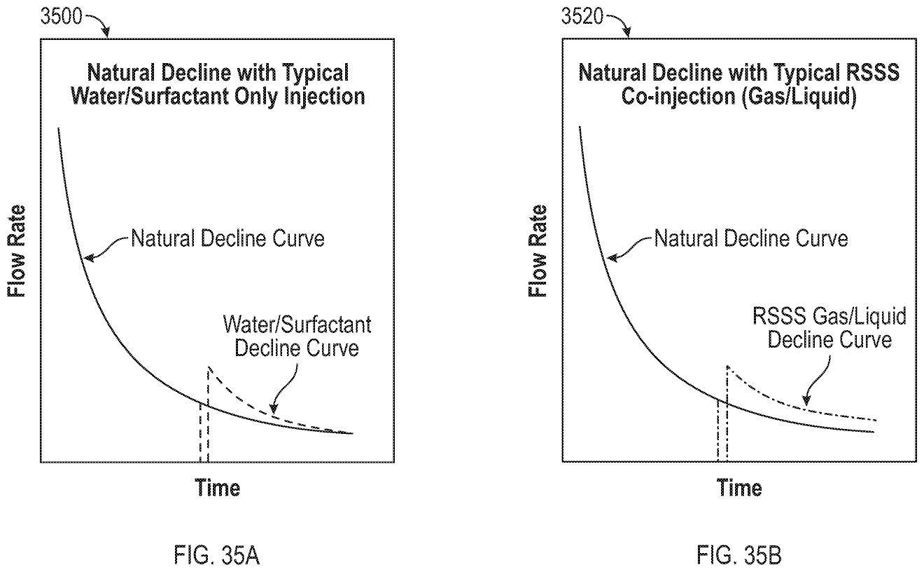

With reference to FIGS. 35A and 35B, which show simplified well-production flow-rate decline graphs 3500 and 3520, the RSSS co-injection process provides improved EOR characteristics as compared to water-only or water-and-surfactant injection. The liquid segments 3230 delivered by pump fluid delivery system 3220 stimulates the near-wellbore region, while gas segments 3240 contributes a compressible gas that supports longer-term reservoir re-pressurization as a result of the co-injection RSSS methods. In advantageous aspects, this enables the reservoir around wellbore 10 to experience extended pressure support that is not achievable with water-based injection alone. As shown in graph 3500, water and surfactant only injection has a steeper decline that ultimately results in the same flow rate after the same period of time as the natural flow rate. In comparison, as shown in graph 3520, An RSSS co-injection of liquid and gas segments improves the flow rate, leading to a stronger flow rate after the same period of time, thus increasing production over the same period of time, and can thus sustain extended and/or improved production over the life of the well.

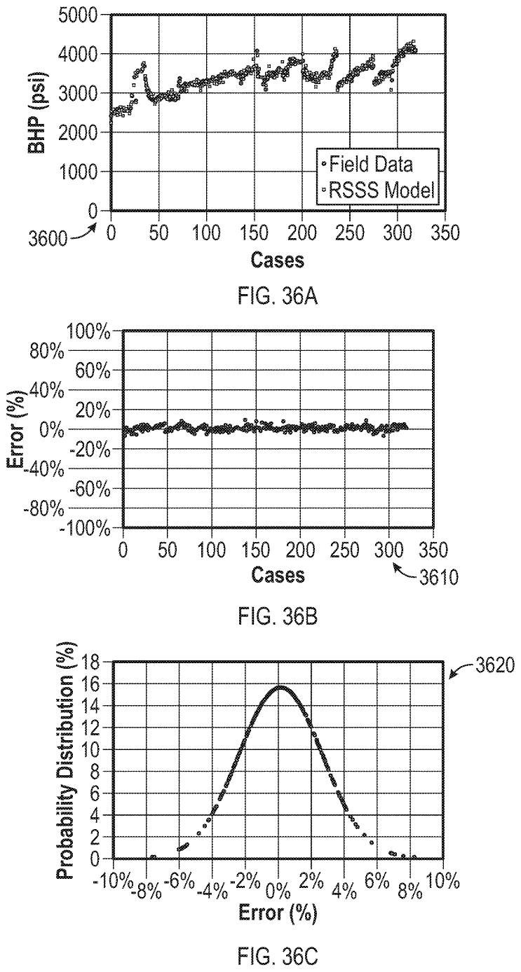

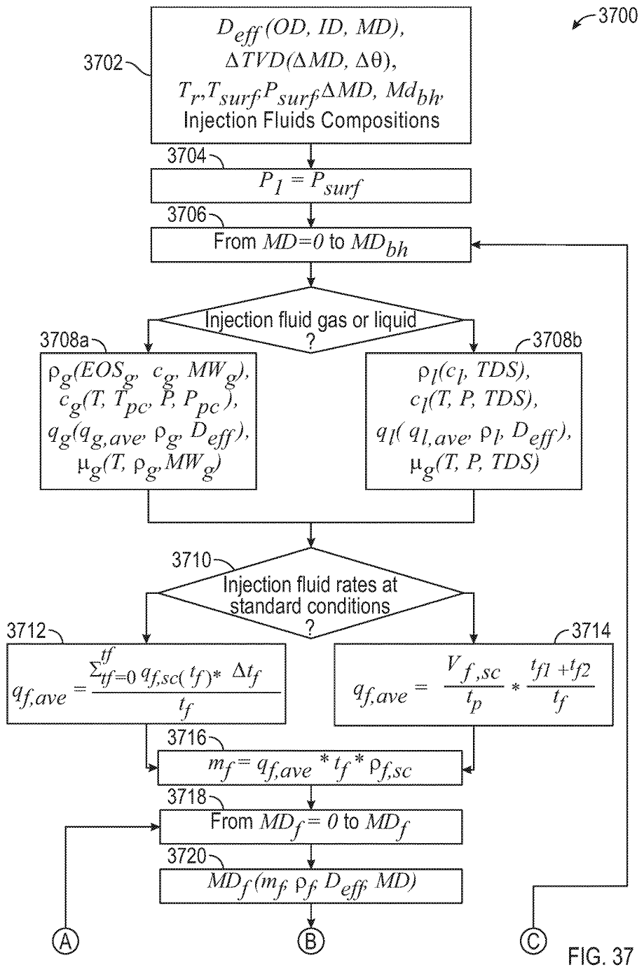

With reference to FIGS. 36A-C, pressure behavior in the wellbore during operation of the EOR system 3200 may be modeled to determine bottomhole pressure and enable operators to optimize EOR system 3200. The model represents the downward movement of alternating liquid segments 3230 and gas segments 3240, and uses the respective fluid properties of the liquid and gas fluids to predict the bottomhole pressure and fluid behavior as each liquid and gas segments 3230, 3240 advance. The model determines, using the fluid properties of the liquid and gas used in the EOR system 3200, the hydrostatic pressure contribution of each fluid to predict the bottomhole pressure. For example, the model may may use the density, viscosity, compressibility, and/or temperature-dependent properties of each fluid, and/or the depth of each fluid within the wellbore (e.g., the depth of each liquid and/or gas segments 3230, 3240), and/or incorporates frictional losses that arise from changes in flow rate, wellbore diameter, and/or segment sequencing, including the length and/or volume of each liquid and/or gas segment 3230, 3240. In some aspects, the model uses wellbore geometries to adjust the calculated hydrostatic pressure profile and to account for changes in vertical flow behavior associated with alternating liquid and gas segments 3230, 3240.

In aspects, the model may use one or more assumptions to simplify prediction of the pressure profile in the wellbore. For example, when each liquid and/or gas segment 3230, 3240 enters wellbore 10 at the surface, the flow rate of the liquid segment 3230 and the flow rate of the gas segment 3240 may be assumed to be approximately equal. In aspects, the EOR system 3200 may be configured so that fluid dispensing system 3220 may meter the liquid and gas segments 3230, 3240 in a manner that satisfies the approximately equal-flow-rate assumption at the surface. In another example, the liquid segments 3230 and gas segments 3240 may be assumed not to mix as they move downward through at least a portion of, or all of, the vertical section of the wellbore.

As illustrated by graphs 3600, 3610, and 3620, respectively shown in FIGS. 36A, 36B, and 36C, modeling of the EOR system 3200 effectively predicts the pressure profile in the wellbore during operation of the EOR system 3200. The modeling of the EOR system 3200 indicates that minimal mixing occurs between the liquid and gas segments 3230, 3240, supporting the assumption discussed above for modeling the pressure profile within the wellbore. Graph 3500 shows a model of a wellbore bottom-hole pressure versus example real field data, illustrating the accuracy of modeling the EOR system 3200 based on the fluid properties and parameters of the liquid and gas segments 3230, 3240 in the wellbore. Graph 3510 shows corresponding percent error per case of each pressure prediction in graph 3500. Graph 3520 illustrates a normal-distribution curve of the percent error per case, with a representative standard deviation of approximately 2.53 percent.

In advantageous aspects, modeling of the EOR system 3200 enables operators to adjust the EOR system to achieve optimal results. For example, the operator may select a different liquid and/or gas and/or ratio to meet a target bottomhole pressure. In another example, the operator may adjust liquid segment and gas segment lengths to set hydrostatic pressure contribution and/or cycle timing. In more than one example, the operator may enable a booster compressor (e.g., 3260) to raise gas supply pressure to the selected equipment class. For example, the operator may operate in bubble-flow injection configuration by holding the gas valve open while cycling the liquid valve to entrain gas within liquid segments, as disclosed above. In more examples, the operator may introduce diverter media and/or viscosity-increasing agents into selected liquid segments 3230 to improve transport of diverting media. In additional examples, the operator may vent buffer tank gas to a lower pressure system during liquid filling to reduce pump discharge pressure and power use.

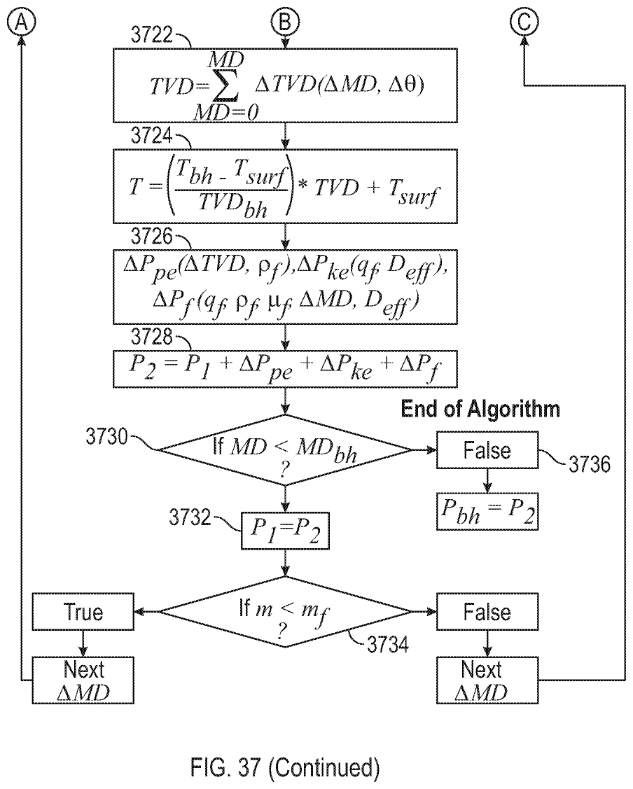

FIG. 37 illustrates a block diagram of a method 3700 for generating a model of bottomhole pressuring during co-injection of liquid and gas segments into a wellbore. As disclosed herein, an EOR system (e.g., 3200), is operable to facilitate RSSS injections using two fluids, a denser fluid, generally a liquid characterized as a slug (e.g., 3230), and a lighter fluid, either a gas or liquid characterized as a bubble (e.g, 3240). During RSSS co-injection, the slugs and bubbles are alternately introduced at the surface to keep the two fluids separated in the vertical, or near vertical, wellbore as they move downward towards the injection interval. This allows for the use of the denser fluid's hydrostatic gradient to increase bottom hole pressure P_{bh} and maintain injectivity while the surface injection pressure remains relatively constant.

To model the P_{bh} during the RSSS co-injection processes, one or more parameters of the wellbore are determined at operation 3702. A wellbore schematic may be obtained that includes a beginning measured depth “MD” and ending MD, outer diameter “OD” of the wellbore, inner diameter “ID” of the wellbore, and weight per foot of all casing, production tubing, producing interval piping, valves, packers, and bottom hole configuration. Then the diameters of all pipes can be used to calculate the effective diameter of the flow path “D_{eff}” as a function of OD, ID and MD. A normal reservoir temperature “Tᵣ” may also be determined. Surface parameters to be determined include a surface injection path pressure P_{surf} and temperature T_{surf}, an assumed bottom hole temperature T_{bh}, one or more timing settings “t_{f}” for alternating between fluids, including a first timing setting t_{f1} and a second timing setting t_{f2} during injection period “tₚ”. Flow rates for each individual gas segment or liquid segment as a function of time q_{f}(t) is determined where 0<t<t_{f}. In aspects, total injected volumes of both fluids V_{f} when both fluid timing settings, t_{f}, are constant and alternating over an extended period, tₚ may be used to determine average flow rates of each individual gas segment or liquid segment.

A drilling survey may be performed or received that represents the well trajectory as MD segments each having a corresponding deviation angle θ for a portion of or all of the well. The bottomhole MD of the vertical, or near vertical, portion of the wellbore “MD_{bh}” can be attained. The total vertical depth TVD can be calculated as a function of changes in MD and θ. For the gas injection portion of RSSS co-injection, gas segment parameters are determined. The gas segment parameters determined include at least one of the molecular weight “MW_{g}” of the gas segment, density “ρ_{g}” of the gas segment, viscosity “μ_{g}”, pseudo critical temperature “T_{pc}”, pseudo critical pressure “P_{pc}”, equation of state parameters “EOS_{g}”, and gas compressibility “c_{g}”. For the liquid segments (e.g., 3230), parameters include fluid density ρₗ, fluid viscosity μₜ, and/or fluid compressibility cₗ and may include a liquid composition with total dissolved solids “TDS”, if any dissolved solids or solvents may be present.

Starting at the surface measurements of T_{surf} and P_{surf}, P₁ is set as P_{surf} at operation 3704. The next pressure P₂ is calculated by accounting for the changes in pressure due to potential energy ΔPₚₑ, kinetic energy ΔPₖₑ and frictional losses ΔP_{f} in a chosen increment of measured depth AMD:

$${P}_{2} = {P}_{1} + Δ {P}_{p e} + Δ {P}_{k e} + Δ {P}_{f}$$

wherein ΔPₖₑ is the pressure change due to kinetic energy associated with fluid velocity in the increment and ΔP_{f} is the pressure loss due to frictional effects in the increment.

Where a given fluid:

ΔPₚₑ (ΔTVD, ρ_{f})
ΔPₖₑ (q_{f}, D_{eff})
ΔP_{f} (q_{f}, ρ_{f}, μ_{f}, ΔMD, D_{eff})

Wherein g_{f} is the volumetric flow rate of the fluid segment occupying the measured depth increment and D_{eff} is the effective diameter of the flow path for that increment. ΔP_{f} is the pressure loss due to viscous and wall-friction effects. ρ_{f} is the density of the fluid segment, μ_{f} is the dynamic viscosity of the fluid segment, and ΔMD is the measured depth increment over which the frictional loss is calculated.

For gas density, flow rate, and viscosity:

ρ_{g}(EOS_{g}, c_{g}, MW_{g})
c_{g}(T, T_{pc}, P, P_{pc})
q_{g}(q_{g,ave}, ρ_{g}, D_{eff})
μ_{g}(T, ρ_{g}, MW_{g})

D_{eff} is the effective hydraulic diameter of the active flow path determined from the outer diameter OD and inner diameter ID of wellbore components at a given measured depth MD. q_{q} is the in-situ gas flow rate in the wellbore determined from the average gas flow rate at standard conditions q_{(g,ave)} adjusted for gas density and flow path diameter. μ_{g} is the gas viscosity determined as a function of local temperature T, gas density ρ_{g}, and gas molecular weight MW_{g}.

For liquid density, flow rate, and viscosity:

ρₗ(cₗ, TDS)
cₗ(T, P, TDS)
qₗ(q_{l,ave}, ρₗ, D_{eff})
μₗ(T, P, TDS)

ρₗ is the density of the liquid segment determined based on liquid compressibility cₗ and total dissolved solids concentration TDS. cₗ is the liquid compressibility determined as a function of temperature T, pressure P, and total dissolved solids concentration TDS. qₗ is the in-situ liquid flow rate in the wellbore determined from the average liquid flow rate at standard conditions q_{(l,ave)} adjusted for liquid density and effective diameter. μ is the liquid viscosity determined as a function of temperature T, pressure P, and total dissolved solids concentration TDS.

Where the effective diameter and change in total vertical depth are:

D_{eff} (OD, ID, MD)
ΔTVD (ΔMD, Δθ)

The pressure calculation traverses down the vertical, or near vertical, portion of the wellbore in chosen increments of measured depth while alternating between the two fluids based on the length of wellbore filled by a slug or bubble MDs:

$$M {D}_{f} ( {m}_{f} , {ρ}_{f} , {D}_{eff} , Δ MD )$$

MD_{f} is the measured-depth length of a slug or bubble occupying the wellbore, determined from the mass m_{f} of the fluid segment and the effective cross-sectional flow area.

Where mass conservation is kept by calculating the mass m_{f} of each slug and bubble by:

$${m}_{f} = {q}_{f , ave} * {t}_{f} * {ρ}_{f , sc}$$

wherein t_{f} is the injection time for the segment, and ρ_{(f,sc)} is the fluid density at standard conditions.

The average flow rate at standard conditions for an injection fluid q_{f,ave} is determined by:

$${q}_{f , ave} = \frac{{\sum }_{{t}_{f} = 0}^{{t}_{f}} {q}_{f , sc} ( Δ {t}_{f} ) * Δ {t}_{f}}{{t}_{f}}$$

In aspects, flow rates at standard conditions are averaged over an extended period, tₚ:

$${q}_{f , ave} = \frac{{V}_{f , sc}}{{t}_{p}} * \frac{{t}_{f 1} + {t}_{f 2}}{{t}_{f}} ,$$

wherein V_{(f,sc)} is the total injected volume at standard conditions over an extended injection period tₚ and t_{f1} and t_{f2} are alternating injection timing intervals for the two fluids.

The temperature T from the surface injection temperature throughout an assumed bottom hole temperature T_{bh} can be found using a linear approximation. Where at the chosen bottom hole total vertical depth TVD_{bh}:

$$T = ( \frac{{T}_{bh} - {T}_{surf}}{T V {D}_{b h}} ) * TVD + {T}_{surf} .$$

The assumed bottom hole temperature is usually between the surface injection temperature and reservoir temperature:

$${T}_{surf} < {T}_{b h} < {T}_{r} .$$

Any total vertical depth can be calculated by the summation of all increments of total vertical depth as a function of measured depth and corresponding deviation angles:

$$TVD = {\sum }_{M D = 0}^{M D} Δ T V D ( Δ MD , Δθ ) .$$

At operation 3702, the method determines the parameters used to model bottomhole pressure P_{bh}, including wellbore geometry and measured depth information used to determine the various parameters shown in the above equations, including an effective flow diameter D_{eff} and total vertical depth TVD, surface pressure P_{surf} and surface temperature T_{surf}, an assumed bottomhole temperature T_{bh}, bottomhole measured depth, and properties of injected fluids. These parameters establish the geometric, thermal, and fluid-property framework for pressure modeling. The surface pressure P_{surf} is assigned as an initial pressure P₁ at operation 3704, and in operation 3706 the method initializes determination of successive pressure of the wellbore from the surface toward the bottomhole.

During operations 3708a and 3708b, the method determines which injection fluid occupies a current segment of the wellbore being evaluated. When the occupying fluid is a gas segment, gas properties such as density, viscosity, compressibility, and flow rate are determined based on gas composition and local conditions using the above gas segment equations and parameters. When the occupying fluid is a liquid segment, corresponding liquid properties are determined, optionally accounting for dissolved solids, using the above fluid segment equations and parameters. At operation 3710, the method evaluates how injection flow rates are specified and determines an average flow rate at standard conditions based on either time-varying flow rates over an injection interval or total injected volume over an extended period, as determined in operations 3712 and/or 3714.

Using the determined average flow rate and injection timing, the method calculates the mass of an injected slug or bubble at operation 3716. Operations 3718 and 3720 determine the measured-depth length of the current fluid segment from the segment mass, fluid properties, and effective flow diameter, thereby defining the portion of the wellbore occupied by the segment. For each depth increment within the segment, the corresponding total vertical depth is calculated at operation 3722, and the local temperature is determined at operation 3724 using a depth-based approximation between surface and bottomhole temperatures.

At operation 3726, the method calculates incremental pressure changes for the current depth increment by accounting for hydrostatic effects, kinetic energy effects, and frictional losses associated with the occupying fluid (the gas or liquid segment). The pressure at the bottom of the increment is then calculated at operation 3728 by updating the pressure from the top of the increment. The method evaluates, at operation 3730, whether the bottomhole depth has been reached and, if not, updates the pressure and determines at operation 3734 whether the current fluid segment has been fully traversed before continuing traversal. If m<m_{f} at operation 3734, then the current segment of gas or liquid mass has not yet been spent. The method proceeds to operation 3718 to calculate pressure changes for the next MD segment using the current gas or liquid properties. If m is not less than m_{f} at operation 3734, then the current segment of gas or liquid mass has been spent. The method proceeds to operation 3706 to switch to the opposite phase and initiate calculation of changes in pressure using properties as functions as described at operation 3708a or 3708b. If at operation 3730, it is determined that the bottomhole depth was reached, the calculated pressure is assigned as the bottomhole pressure P_{bh} at operation 3736, and the method terminates. The pressure at each measured depth may be used to inform operation of the EOR system or an RSSS process, to tailor operation thereof to maximize the production of the wellbore.

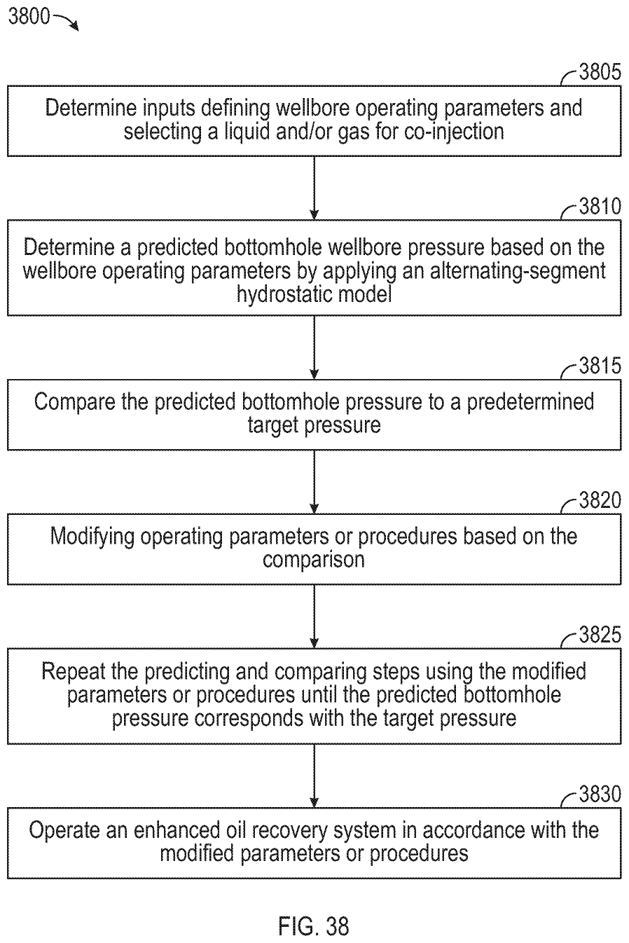

FIG. 38 illustrates a flow diagram of a method 3800 for modeling co-injection of liquid and gas segments into a wellbore includes one or more of the following operations. In operation 3805, inputs are determined to define wellbore operating parameters including current or assumed operating conditions and/or baseline operating parameters. The wellbore operating parameters may include one or more of: wellbore depth, pre-injection reservoir and/or wellbore pressure, wellbore geometry, gas and/or liquid flow rate, gas and/or liquid segment length, surface pressure, surface temperature, fluid properties of a selected gas or selected liquid, a buffer tank level, buffer tank density data, and/or an operating procedures. Operation 3805 further includes selecting a liquid and/or selecting a gas for co-injection, such that the model receives at least the selected liquid and/or the selected gas and the wellbore parameters. The method 3800 supports a predictive mode in which one or more wellbore operating parameters are assumed. The operating procedure includes any mode or combination of co-injecting liquid and gas segments as disclosed herein.

In operation 3810, a predicted bottomhole wellbore pressure is determined based on the determined wellbore operating parameters. Operation 3810 may include applying an alternating-segment model that sums hydrostatic pressure contributions of the liquid and/or gas segments (e.g., 3230, 3240, respectively). In aspects, operation 3810 may include estimating frictional losses. In aspects, the wellbore pressure may be determined based on selecting one or more assumptions including assumption of approximately equal phase entry rates and/or assumption of limited phase mixing in the vertical section of the wellbore. Operation 3810 may include determining the bottomhole wellbore pressure and pressure behavior from the selected liquid and/or the selected gas and the wellbore parameters without real-time field data.

In operation 3815, the predicted bottomhole wellbore pressure is compared to a predetermined target wellbore pressure. In operation 3820, operating parameters are modified based on the comparison of the predicted bottomhole wellbore pressure and the predetermined target wellbore pressure. Operation 3820 may include selecting at least one different operating parameter and/or operating procedure including at least one of: a liquid, a gas, a wellbore depth, a pre-injection wellbore pressure, a wellbore geometry, a gas and/or a liquid flow rate, a gas and/or a liquid segment length, a surface pressure, a surface temperature, fluid properties of a selected gas or selected liquid, and/or a buffer tank level and/or density data. Selecting the liquid and/or gas may be based on wellbore or reservoir conditions. For example, the selected fluids may be chosen based on soil compositions of the wellbore, depth of the wellbore, pressure of the wellbore, and/or other well or surface conditions to optimize efficiency and performance of EOR system 3200. In aspects, operation 3820 includes modifying operating parameters by adjusting one or more of gas flow rate, liquid flow rate, segment length, and/or surface pressure to achieve the predetermined target pressure. In more aspects, modifying one or more operating parameters may be performed when the predicted bottomhole pressure deviates, for example, by more than 5% from the predetermined target pressure. In more aspects, the modifying one or more operating parameters is performed if the predicted bottomhole pressure deviates from the predetermined target pressure by a predetermined deviance threshold, which may be, for example, 2%, 2.3%, 5%, or 10%, or any desired deviance threshold based on an acceptable tolerance by the wellbore operators.

In aspects, operation 3825 repeats operations 3810 using the one or more different operating parameters and/or operating procedures, and repeats operation 3815 until a desired bottomhole wellbore pressure is predicted. Operation 3830 includes operating an EOR system, such as EOR system 3200, according to the operating parameters and/or operating procedures used to determine the desired bottomhole wellbore pressure.

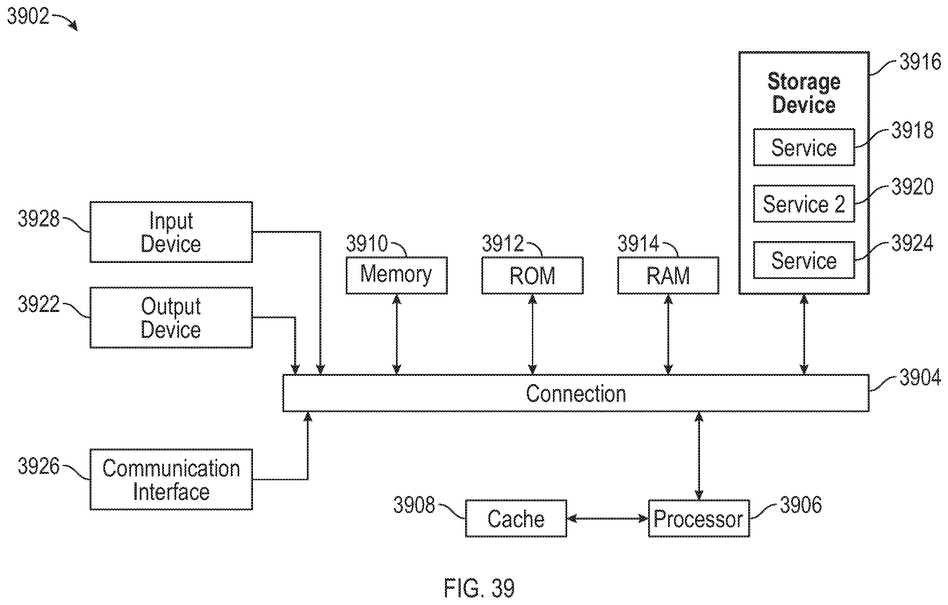

FIG. 39 illustrates an example computing device architecture 3902 which can be employed to perform various operations, methods, and techniques disclosed herein. The various implementations will be apparent to those of ordinary skill in the art when practicing the present technology. Persons of ordinary skill in the art will also readily appreciate that other system implementations or examples are possible.

As noted above, FIG. 39 illustrates an example computing device architecture 3902 of a computing device which can implement the various technologies and techniques described herein. The components of the computing device architecture 3902 are shown in electrical communication with each other using a connection 3904, such as a bus. The example computing device architecture 3902 includes a processing unit (CPU or processor) 3906 and a computing device connection 3904 that couples various computing device components including the computing device memory 3910, such as read only memory (ROM) 3912 and random access memory (RAM) 3914, to the processor 3906.

The computing device architecture 3902 can include a cache of high-speed memory connected directly with, in close proximity to, or integrated as part of the processor 3906. The computing device architecture 3902 can copy data from the memory 3910 and/or the storage device 3916 to the cache 3908 for quick access by the processor 3906. In this way, the cache can provide a performance boost that avoids processor 3906 delays while waiting for data. These and other modules can control or be configured to control the processor 3906 to perform various actions. Other computing device memory 3910 may be available for use as well. The memory 3910 can include multiple different types of memory with different performance characteristics. The processor 3906 can include any general purpose processor and a hardware or software service, such as service 3918, service 3920, and/or service 3924 stored in storage device 3916, configured to control the processor 3906 as well as a special-purpose processor where software instructions are incorporated into the processor design. The processor 3906 may be a self-contained system, containing multiple cores or processors, a bus, memory controller, cache, etc. A multi-core processor may be symmetric or asymmetric.

To enable user interaction with the computing device architecture 3902, an input device 3928 can represent any number of input mechanisms, such as a microphone for speech, a touch-sensitive screen for gesture or graal input, keyboard, mouse, motion input, speech and so forth. An output device 3922 can also be one or more of a number of output mechanisms known to those of skill in the art, such as a display, projector, television, speaker device, etc. In some instances, multimodal computing devices can enable a user to provide multiple types of input to communicate with the computing device architecture 3902. The communications interface 3926 can generally govern and manage the user input and computing device output. There is no restriction on operating on any particular hardware arrangement and therefore the basic features here may easily be substituted for improved hardware or firmware arrangements as they are developed.

Storage device 3916 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 3225, read only memory (ROM) 3912, and hybrids thereof. The storage device 3916 can include services 3918, 3234, 3236 for controlling the processor 3906. Other hardware or software modules are contemplated. The storage device 3916 can be connected to the computing device connection 3904. In one aspect, a hardware module that performs a particular function can include the software component stored in a computer-readable medium in connection with the necessary hardware components, such as the processor 3906, connection 3904, output device 3922, and so forth, to carry out the function.

For clarity of explanation, in some instances the present technology may be presented as including individual functional blocks including functional blocks comprising devices, device components, operations or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm operations described in connection with the examples disclosed herein may be implemented as electronic hardware, computer software, firmware, or combinations thereof. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

We claim:

1. A system for conducting enhanced oil recovery, the system comprising:
a buffer tank configured to hold a liquid and a gas, the buffer tank including a level sensor configured to determine a level of the liquid, the gas, and/or a liquid-gas mixture thereof; and
a fluid dispensing system in fluid communication with the buffer tank, the fluid dispensing system configured to deliver, using the gas and liquid in the buffer tank, gas segments and liquid segments to a wellbore to establish a plurality of stacked, alternating liquid segments and gas segments travelling downhole into the wellbore;
wherein the level sensor is operable to determine a spectrum of densities from a top of the buffer tank to a bottom of the buffer tank.

2. The system of claim 1, wherein the level sensor is further configured to determine fluid levels within the buffer tank based on vertical density measurements, including when a gas-liquid interface is not defined.

3. The system of claim 1, wherein the level sensor is arranged to detect a gas-liquid interface in foams, emulsions, condensate layers, and/or liquid hydrocarbons and to determine a vertical density profile.

4. The system of claim 1, wherein a selected liquid or gas used with the buffer tank is at least one of: liquid water, y grade gas, carbon dioxide in a dense phase, carbon dioxide in a gaseous phase, and/or natural gas.

5. The system of claim 1, wherein the level sensor comprises a gamma-ray densitometer.

6. A system for conducting enhanced oil recovery, the system comprising:
a buffer tank configured to hold a liquid and a gas; and
a fluid dispensing system in fluid communication with the buffer tank and comprising:
a discharge line directed toward a wellbore;
a gas valve; and
a liquid valve;
wherein the gas valve and the liquid valve are configured to selectively meter the liquid and the gas to the wellbore via the discharge line to produce liquid segments including entrained gas bubbles alternating with gas segments for delivery downhole into the wellbore.

7. The system of claim 6, wherein the gas valve remains open while the liquid valve alternately opens and closes so that liquid segments include entrained gas bubbles and gas segments form during intervals in which the liquid valve is closed.

8. The system of claim 6, further comprising a gas supply and a compressor configured to provide pressurized gas to the buffer tank at a predetermined pressure, and a pump configured to add liquid to the buffer tank, wherein the fluid dispensing system meters overlapping pressurized gas and liquid to produce liquid segments including entrained gas bubbles.

9. The system of claim 6, wherein, by closing the gas valve during production of the liquid segments, at least some liquid segments are produced with no entrained gas bubbles.

10. The system of claim 6, wherein the fluid dispensing system is configured to inject, via the discharge line, liquid segments including entrained gas bubbles through smaller diameter tubing into the wellbore while maintaining flow stability and pressure control, wherein the smaller diameter tubing may include an internal diameter from about 1 inches to about 6 inches.

11. The system of claim 6, wherein a selected liquid or gas used with the buffer tank is at least one of: liquid water, y grade gas, carbon dioxide in a dense phase, carbon dioxide in a gaseous phase, and/or natural gas.

12. The system of claim 6, wherein the fluid dispensing system is configured to reduce hammer effects by balancing pressure metering the liquid segments including entrained gas bubbles.

13. A method for modeling co-injection of liquid and gas segments into a wellbore, the method comprising:
determining inputs defining wellbore operating parameters and selecting a liquid and/or a gas for co-injection into the wellbore;
determining a predicted bottomhole wellbore pressure based on the wellbore operating parameters by applying an alternating-segment hydrostatic pressure model;
comparing the predicted bottomhole pressure to a predetermined target pressure;
modifying one or more operating parameters based on the comparison;
repeating the determining a predicted wellbore bottomhole pressure and comparing steps using the modified operating parameters until the predicted bottomhole pressure corresponds with the target pressure; and
operating an enhanced oil recovery system in accordance with the modified operating parameters.

14. The method of claim 13, wherein the wellbore operating parameters include at least one of a wellbore depth, a wellbore geometry, a pre-injection wellbore pressure, a gas flow rate, a liquid flow rate, a gas segment length, a liquid segment length, a surface pressure, a surface temperature, a fluid property of a selected gas, a fluid property of a selected liquid, a buffer tank level, buffer tank density data, and/or an operating procedure.

15. The method of claim 13, wherein predicting bottomhole wellbore pressure further includes estimating frictional pressure losses.

16. The method of claim 13, further comprising selecting the liquid and gas based on reservoir conditions to optimize injection performance.

17. The method of claim 13, wherein modifying operating parameters includes adjusting one or more of gas flow rate, liquid flow rate, segment length, or surface pressure to achieve the predetermined target pressure.

18. The method of claim 13, wherein modifying operating one or more operating parameters is performed when the predicted bottomhole pressure deviates by more than 5 percent from the predetermined target pressure.

19. The method of claim 13, wherein operating the enhanced oil recovery system includes injecting alternating slugs of gas and liquid into the wellbore according to the determined operating parameters.

20. The method of claim 13, wherein determining the predicted bottomhole wellbore pressure is further based on at least one wellbore assumption, wherein the at least one wellbore assumption includes at least one of:
assumption of approximately equal flow rate between co-injected liquid segments and gas segments; and/or
assumption that the co-injected liquid segments and gas segments do not mix in a vertical wellbore section.
